(19) United States
(12) Patent Application Publication
(10) Pub. No.: US 2026/0332302 A1
(43) Pub. Date: Oct. 22, 2026

(54) DTMF SUBSTITUTION IN AUDIO CODEC PAYLOADS

(71) Applicant: Lenovo (United States) Inc., Morrisville, NC (US)

(72) Inventors: Razvan-Andrei Stoica, Essen (DE); James Ashley, Naperville, IL (US)

(73) Assignee: Lenovo (United States) Inc., Morrisville, NC (US)

(21) Appl. No.: 19/633,746

(22) Filed: Mar. 30, 2026

(51) Int. Cl. H04L 1/00

(52) U.S. Cl. CPC H04L 1/0069; H04L 1/0071

(57) ABSTRACT

Various aspects of the present disclosure relate to substituting dual-tone multi-frequency (DTMF) events into audio codec payloads. A node, such as a user equipment (UE) or a network entity (NE), detects a DTMF event and substitutes a binary representation of the DTMF event into an audio codec payload. The binary representation may encode a DTMF event identifier using a reduced number of bits compared to a conventional DTMF payload. The node releases the audio codec payload to a lower layer for transmission. In some examples, the node performs distributed bit puncturing on audio coded data in the audio codec payload to provide bit positions for the binary representation of the DTMF event. In some examples, the binary representation of the DTMF event is included as a header extension within a codec payload header of the audio codec payload.

### TECHNICAL FIELD

The present disclosure relates to wireless communications, and more specifically to audio codec payload transport for voice services.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

The devices (e.g., NE, UE), processors, and methods of the present disclosure each have several innovative aspects, no single one of which is solely responsible for the desirable features disclosed herein.

A node (e.g., an NE, a UE) for wireless communication is described. The node may be configured to, capable of, or operable to perform one or more operations as described herein. For example, the node may be configured to, capable of, or operable to detect a dual-tone multi-frequency (DTMF) event, substitute a binary representation of the DTMF event into an audio codec payload, and release the audio codec payload to a lower layer for transmission.

A processor (e.g., a standalone processor chipset, or a component of a node) for wireless communication is described. The processor may be configured to, capable of, or operable to perform one or more operations as described herein. For example, the processor may be configured to, capable of, or operable to detect a DTMF event, substitute a binary representation of the DTMF event into an audio codec payload, and release the audio codec payload to a lower layer for transmission.

A method performed or performable by a node for wireless communication is described. The method may include detecting a DTMF event, substituting a binary representation of the DTMF event into an audio codec payload, and releasing the audio codec payload to a lower layer for transmission.

In some implementations of the node, the processor, and the method described herein, the node, the processor, and the method may further be configured to, capable of, or operable to perform distributed bit puncturing on audio coded data in the audio codec payload to provide bit positions for the binary representation of the DTMF event. In some implementations of the node, the processor, and the method described herein, the node, the processor, and the method may further be configured to, capable of, or operable to determine a puncturing mask indicating the bit positions, and to determine the puncturing mask, the node, the processor, and the method may further be configured to, capable of, or operable to select a group of coded audio features based on a reliability pattern of the audio coded data, and select, based on the reliability pattern, a set of quantized bits of one or more of the coded audio features.

In some implementations of the node, the processor, and the method described herein, the node, the processor, and the method may further be configured to, capable of, or operable to select an interleaving pattern for the bit positions indicated by the puncturing mask, and apply the interleaving pattern to interleave the bit positions with remaining bits of the audio coded data. In some implementations of the node, the processor, and the method described herein, to substitute the binary representation of the DTMF event, the node, the processor, and the method may further be configured to, capable of, or operable to replace bits at the bit positions indicated by the puncturing mask with the binary representation of the DTMF event.

In some implementations of the node, the processor, and the method described herein, presence of the binary representation of the DTMF event in the audio codec payload is indicated by a presence bit. In some implementations of the node, the processor, and the method described herein, the presence bit is included in a codec payload header of the audio codec payload. In some implementations of the node, the processor, and the method described herein, an end of the DTMF event is indicated by an end bit. In some implementations of the node, the processor, and the method described herein, the end bit is included in a codec payload header of the audio codec payload. In some implementations of the node, the processor, and the method described herein, the binary representation of the DTMF event is prefixed to the audio codec payload to form a header extension included within a codec payload header of the audio codec payload. In some implementations of the node, the processor, and the method described herein, the audio codec payload includes the binary representation of the DTMF event as a DTMF-only payload excluding audio coded data.

In some implementations of the node, the processor, and the method described herein, the binary representation of the DTMF event encodes at least a DTMF event identifier. In some implementations of the node, the processor, and the method described herein, the lower layer includes at least one of a real-time transport protocol (RTP) layer, where the audio codec payload is transmitted via RTP over user datagram protocol (UDP) and Internet protocol (IP), or a non-IP protocol layer, where the audio codec payload is transmitted over a radio layer-2 protocol. In some implementations of the node, the processor, and the method described herein, the node, the processor, and the method may further be configured to, capable of, or operable to negotiate, via a session description protocol (SDP) offer-answer procedure, at least one of a capability to substitute the binary representation of the DTMF event into the audio codec payload, a fixed duration for the DTMF event, or a default playback volume indication for the DTMF event. In some implementations of the node, the processor, and the method described herein, the node, the processor, and the method may further be configured to, capable of, or operable to repeat the substitution of the binary representation of the DTMF event into two or more distinct audio codec payloads.

A node (e.g., an NE, a UE) for wireless communication is described. The node may be configured to, capable of, or operable to perform one or more operations as described herein. For example, the node may include at least one memory, and at least one processor coupled with the at least one memory and operable to cause the node to receive an audio codec payload, extract a binary representation of a DTMF event from the audio codec payload, the binary representation substituted into the audio codec payload, and forward the audio codec payload to an audio decoder for decoding.

A processor (e.g., a standalone processor chipset, or a component of a node) for wireless communication is described. The processor may be configured to, capable of, or operable to perform one or more operations as described herein. For example, the processor may be configured to, capable of, or operable to receive an audio codec payload, extract a binary representation of a DTMF event from the audio codec payload, the binary representation substituted into the audio codec payload, and forward the audio codec payload to an audio decoder for decoding.

A method performed or performable by a node for wireless communication is described. The method may include receiving an audio codec payload, extracting a binary representation of a DTMF event from the audio codec payload, the binary representation substituted into the audio codec payload, and forwarding the audio codec payload to an audio decoder for decoding.

In some implementations of the node, the processor, and the method described herein, to extract the binary representation of the DTMF event, the node, the processor, and the method may further be configured to, capable of, or operable to recover the binary representation of the DTMF event from bit positions in the audio codec payload according to a puncturing mask. In some implementations of the node, the processor, and the method described herein, the node, the processor, and the method may further be configured to, capable of, or operable to perform error concealment on the audio codec payload based on the puncturing mask. In some implementations of the node, the processor, and the method described herein, to extract the binary representation of the DTMF event, the node, the processor, and the method may further be configured to, capable of, or operable to read the binary representation of the DTMF event from a header extension of a codec payload header of the audio codec payload.

### BRIEF DESCRIPTION OF FIGURES

Non-limiting and non-exhaustive examples are described with reference to the following figures.

FIG. 1 illustrates an example of a wireless communications system, in accordance with aspects of the present disclosure.

FIG. 2 illustrates an example RTP protocol data unit (PDU), in accordance with aspects of the present disclosure.

FIG. 3A illustrates an example RTP payload format, in accordance with aspects of the present disclosure.

FIG. 3B illustrates an example of DTMF telephony event codepoints, in accordance with aspects of the present disclosure.

FIG. 4 illustrates an example non-IP transport architecture for IP Multimedia Subsystem (IMS) Voice, in accordance with aspects of the present disclosure.

FIG. 5 illustrates an example reduced DTMF event representation, in accordance with aspects of the present disclosure.

FIGS. 6 and 7 illustrate examples of signal processing flows, in accordance with aspects of the present disclosure.

FIGS. 8A and 8B illustrate examples of audio codec payload structures, in accordance with aspects of the present disclosure.

FIG. 9 illustrates an example of a UE in accordance with aspects of the present disclosure.

FIG. 10 illustrates an example of a processor in accordance with aspects of the present disclosure.

FIG. 11 illustrates an example of an NE in accordance with aspects of the present disclosure.

FIG. 12 illustrates a flowchart of a method performed by a node in accordance with aspects of the present disclosure.

FIG. 13 illustrates a flowchart of a method performed by a node in accordance with aspects of the present disclosure.

### DETAILED DESCRIPTION

In a wireless communications system, a UE and an NE (e.g., a base station, gNB) may support wireless communication (e.g., reception and/or transmission of wireless communication) using time-frequency resources. In some scenarios, voice connectivity or improved voice connectivity may be desired in remote areas that are outside of terrestrial network coverage. The wireless communications system may support voice services over satellite access to extend coverage to such areas. For example, geostationary Earth orbit (GEO) satellite connectivity may provide coverage via technologies such as Narrowband Internet of Things (NB-IoT) non-terrestrial network (NTN) radio access. However, narrowband GEO links may be constrained by an operating spectrum (e.g., to 200 kilohertz (kHz) bands) and may be capacity constrained at both system and link levels, with typical link capacities in the range of 1-3 kilobits per second (kbps). As a result, voice communications supported by such services may be inefficient, both in terms of audio codec bit rates and protocol encapsulation of voice data packets. Additionally, support for DTMF telephone events may provide a complete telephony experience. As used herein, a DTMF “event” refers to an occurrence of a user pressing a button on a telephone keypad, resulting in a corresponding DTMF tone that may be signaled to a remote device or system. DTMF events allow users to interact with interactive voice response (IVR) systems, banking applications, and other automated answering systems by pressing digits (e.g., 0-9, *, #) on a telephone keypad during a call.

DTMF events may be transported during a call session in multiple ways. In a first approach, DTMF events are transported out-of-band in the media plane as named telephone events, where each DTMF event is encapsulated in a separate RTP packet that is multiplexed with the RTP audio packets. This approach adds overhead of approximately 4 bytes per DTMF event, which may consume a significant portion of the available bit rate when operating at ultra-low rates such as 1 kbps or less. In a second approach, DTMF events are transported in-band in the media plane, where the DTMF tones are treated as audio signals and encoded directly into the audio codec bitstream. However, at ultra-low bit rates, audio coders may introduce aliasing that distorts the tones and impacts DTMF tone detection at the receiver, or alternatively, impact overall perceptual audio quality. In a third approach, DTMF events are transported via session initiation protocol (SIP) INFO messages in the signaling plane. However, this approach may have a higher impact on bandwidth for GEO communications due to SIP signaling overhead, and timing synchronization between voice packets and DTMF tones may be affected because they follow different network signaling paths.

Accordingly, the techniques described herein provide methods for embedding DTMF event information into an audio codec payload, thereby enabling DTMF events even in areas outside of terrestrial network coverage or in areas having low terrestrial network coverage. A node (e.g., a UE, an NE, or the like) may detect a DTMF event and substitute a binary representation of the DTMF event into an audio codec payload. The binary representation may encode a DTMF event identifier using a reduced number of bits compared to a conventional DTMF payload. The node may embed the binary representation by puncturing bit positions in audio coded data within the audio codec payload and substituting the binary representation at the punctured bit positions. Alternatively, the node may embed the binary representation as a header extension within a codec payload header of the audio codec payload. A presence bit in the codec payload header may indicate whether the binary representation of the DTMF event is present in the audio codec payload. The node releases the audio codec payload to a lower layer for transmission, where the lower layer may include an RTP layer for IP-based transport or a non-IP protocol layer for transport over a radio layer-2 protocol.

The described techniques provide improvements in DTMF transport efficiency for bandwidth-constrained communications. By substituting a binary representation of a DTMF event into the audio codec payload rather than transmitting DTMF events in separate RTP packets, the techniques described herein reduce overhead associated with DTMF transport. When the binary representation is embedded by puncturing bit positions in audio coded data, no additional overhead is added for DTMF transport, relying on error concealment capabilities of an audio decoder at a receiving node to mitigate any distortion introduced by the punctured bits. When the binary representation is included as a header extension, a minimal number of bits (e.g., 4 bits) are added for DTMF-specific information. The puncturing positions may be determined based on a reliability pattern of the audio coded data, selecting bit positions corresponding to coded audio features or quantized bits that are robust to errors. By selecting bit positions that are robust to errors for puncturing, the techniques described herein may minimize perceptual impact on decoded audio quality. Additionally, by negotiating the capability to substitute the binary representation of the DTMF event into the audio codec payload via a session description protocol (SDP) offer-answer procedure, the described techniques may maintain compatibility with devices that do not support the embedded DTMF approach.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system. Aspects of the present disclosure are further set forth in the accompanying drawings and the description below. The description set forth herein, in connection with the accompanying drawings, describes example implementations and does not represent all the implementations that may be implemented or that are within the scope of the claims. The detailed description includes specific details for the purpose of providing an understanding of the described implementations. These implementations, however, may be practiced without these specific details. Additionally, the description set forth herein, in connection with the accompanying drawings, is provided to enable a person having ordinary skill in the art to make or use the present disclosure. Various modifications to the disclosure will be apparent to a person having ordinary skill in the art, and the generic principles defined herein may be applied to other variations without departing from the scope of the present disclosure. Thus, the present disclosure is not limited to the examples and implementations described herein but is to be accorded the broadest scope consistent with the principles and novel features disclosed herein.

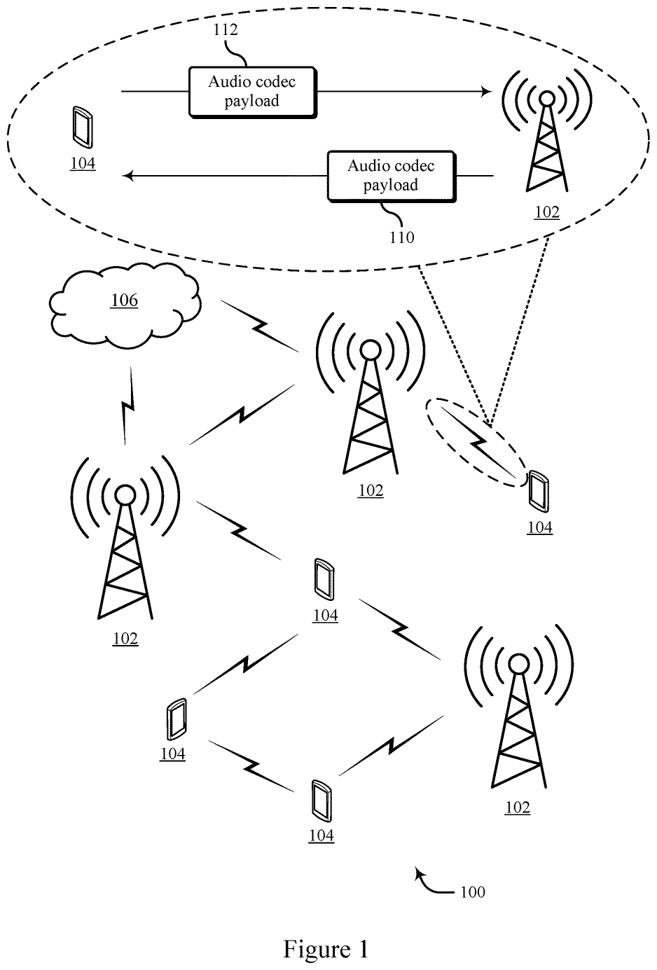

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include/interface or may be referred to as a network node, a base station, an access point (AP), a network element, a network function (e.g., Packet Gateway, User Plane Function, IMS application gateway etc.), a network entity, network infrastructure (or infrastructure), a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NEs 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NEs 102 or the CN 106 through one or more backhaul links (e.g., S1, N2, N6, or other network interface). In some implementations, the NEs 102 may communicate with each other directly. In some other implementations, the NEs 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management function (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1(410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz 300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

An audio codec compresses audio signals into a compact digital representation for transmission and reconstructs the audio at a receiving end. An audio encoder of the audio codec receives an audio signal (e.g., voice) and produces coded audio data, which may also be referred to as audio coded data. The coded audio data forms a bitstream, which is a sequence of bits representing the compressed audio. The bitstream is organized into frames, where each frame corresponds to a time interval of audio (e.g., 20, 40, 80, 160 milliseconds). The output of the audio encoder is referred to as a codec payload, which includes a codec payload header containing metadata about the coded audio data and the coded audio data itself. The codec payload is encapsulated for transport over a network. Upon reception of the codec payload, an audio decoder of the audio codec receives the bitstream and reconstructs the audio signal from the coded audio data.

RTP provides end-to-end delivery services for data with real-time characteristics, such as audio and video. Devices in the wireless communications system 100 utilize RTP to transport voice data over IP networks. An RTP packet includes an RTP header and an RTP payload. The RTP payload encapsulates the codec payload produced by an audio encoder. The RTP header includes fields such as a sequence number for ordering packets, a timestamp for synchronization, and a payload type identifier. RTP packets are carried over UDP and IP.

DTMF signaling conveys information corresponding to button presses on a telephone keypad. When a user presses a button on a telephone keypad (e.g., digits 0-9, special characters * and #, or letters A-D), the device generates a DTMF tone. Each DTMF tone is a combination of two specific frequencies: one from a low-frequency group and one from a high-frequency group. DTMF tones interact with automated systems, such as IVR systems, banking applications, and other automated answering systems. As used herein, a DTMF “event” refers to an occurrence of a user pressing a button on a telephone keypad, resulting in a corresponding DTMF tone that may be signaled to a remote device or system. DTMF events are transported during a voice call to enable users to provide input to such systems.

The device implements voice activity detection (VAD) to detect whether a user is speaking or silent during a voice call. Discontinuous transmission (DTX) allows a transmitter to reduce or cease transmission during silence periods to conserve bandwidth. When DTX is enabled and VAD detects silence, the audio encoder of the device does not produce full audio frames. Instead, the device transmits silence insertion descriptor (SID) frames during silence periods to allow a receiver to generate comfort noise, which provides a more natural listening experience than complete silence.

The codec payload produced by an audio encoder is distinguished from the RTP payload. The codec payload includes a codec payload header and audio coded data. The codec payload header contains metadata about the audio coded data, such as information about the codec mode or frame type. The RTP payload encapsulates the codec payload for transport over a network. In some implementations, the codec payload is transported via RTP over UDP and IP. In other implementations, such as non-IP transport mechanisms, the codec payload is transported over a radio layer-2 protocol without UDP and IP headers.

The IMS provides a service control architecture for delivering voice and multimedia services over packet-switched networks (i.e., IP networks). IMS Voice has been used in mobile networks since third generation (3G) and has continued to evolve across fourth generation (4G) (e.g., Voice over LTE (VoLTE)), 5G (e.g., Voice over New Radio (VoNR)), and into sixth generation (6G). The same IMS core serves both 4G Evolved Packet Core (EPC) and 5G Core (5GC) access. IMS underpins both VoLTE and VoNR telephony, separating signaling (SIP and SDP), media (RTP and RTP control protocol (RTCP)), and policy/charging (Diameter Rx/Gx for 4G, HTTP/2 N 7 for 5G). A UE 104 includes a SIP client that connects through the RAN and packet core to various IMS network functions, including a proxy call session control function (P-CSCF), an interrogating call session control function (I-CSCF), and a serving call session control function (S-CSCF). The P-CSCF functions as an edge SIP proxy and interfaces with a policy and charging rules function (PCRF) in 4G or a policy control function (PCF) in 5G. The I-CSCF provides domain entry functions and queries a home subscriber server (HSS) or unified data management (UDM) function via the Cx interface. The S-CSCF functions as a SIP registrar and invokes application servers via initial Filter Criteria (iFC). Additional IMS elements include a telephony application server (TAS) for multimedia telephony (MMTEL) supplementary services, a media gateway control function (MGCF) and media gateway (MGW) for public switched telephone network (PSTN) and circuit-switched (CS) interworking, a media resource function (MRF) for tones and announcements, and a breakout gateway control function (BGCF) for inter-network breakout routing.

The voice protocol stack for IMS Voice includes multiple layers. An audio codec (e.g., enhanced voice services (EVS), adaptive multi-rate wideband (AMR-WB), or other codecs including ultra-low bit rate codecs) produces audio frames at a frame interval (e.g., 20 milliseconds (ms)). The 20 ms frame interval is selected as it captures vocal tract artifacts, pitch, and timbre while providing sufficient context for highly efficient compression with good perceptual quality. The audio codec supports various audio bandwidths and bit rates. For example, EVS supports narrowband (NB) to fullband (FB) audio at bit rates ranging from 5.9 to 128 kbps, and typically operates at 13.2 kbps super-wideband (SWB) in deployed networks, while AMR-WB fallback operates at wideband (WB) at 12.65 kbps.

Coded audio frames are encapsulated in RTP packets using either full header or compact header payload format. RTP packets are carried over UDP and IP. SIP uses IPSec encapsulating security payload (ESP) encapsulation. At radio Layer 2, packet data convergence protocol (PDCP) applies robust header compression (RoHC) compressing RTP/UDP/IP headers to 1-3 bytes in the most efficient second order (SO) state. During initial packets, RoHC requires a dynamic number of packets to transition from the initiation and refresh (IR) state to the SO state. For example, in unidirectional mode (U-mode), RoHC requires 5-8 packets to reach SO state. Once attained, SO state is preserved for the remainder of the communication assuming no large number of consecutive packets are lost leading to RoHC sequence mismatch or ambiguity. Radio link control (RLC) uses unacknowledged mode (UM) for voice traffic. Medium access control (MAC) uses periodic uplink and downlink scheduling resource allocation (e.g., semi-persistent scheduling (SPS) or configured grants) matching the audio frame period. In 5G, service data adaptation protocol (SDAP) additionally maps quality of service (QoS) flows to data radio bearers (DRBs).

In a typical IMS Voice call, peer UEs and the network perform call setup and codec negotiation before the flow of audio packets begins. A UE 104 registers with IMS using a default non-guaranteed bit rate (non-GBR) bearer to reach an IMS access point name (APN) or data network name (DNN), followed by P-CSCF discovery via protocol configuration options (PCO) and an IPSec encapsulated SIP REGISTER with IMS authentication and key agreement (AKA). For a mobile-originated call, the calling UE 104 sends a SIP INVITE message with an SDP offer listing available codecs and other media configurations. The P-CSCF forwards the SIP INVITE to the S-CSCF, which invokes the TAS via iFC and forwards the processed SIP INVITE to the called UE 104.

Concurrently, the P-CSCF signals a policy entity (e.g., PCRF or PCF) via Diameter AA-Request (AAR) to authorize a dedicated GBR bearer. The CN 106 triggers dedicated bearer establishment, and the RAN configures a DRB with SPS or configured grants and RoHC via radio resource control (RRC) reconfiguration. The called UE 104 responds with SIP 180 (Ringing) followed by SIP 200 (OK) carrying the SDP answer, which selects one of the offered codec configurations. The calling UE 104 responds with a SIP ACK message, concluding the SIP INVITE procedure and connecting the call. The codec negotiation completes by following the SDP offer-answer procedure.

During the call, RTP audio packets are transported over UDP/IP between the UEs 104. The codec adapts its rate on a frame-by-frame basis via mechanisms such as in-band codec mode request (CMR) triggered by the receiver, network-directed adaptation via explicit congestion notification (ECN) markings or access network bit rate recommendations, or a SIP re-INVITE. When the codec layer detects silence via VAD, DTX sends SID frames. Either UE 104 ends the call with a SIP BYE message. The P-CSCF sends a Diameter session-termination-request (STR) on the Rx interface to the policy entity, triggering dedicated bearer release. The RAN releases the voice DRB via RRC reconfiguration. The default SIP signaling bearer remains active for subsequent calls.

For IMS Voice over NB-IoT NTN access via GEO satellite, voice and IMS signaling packets are transported over the NB-IoT user plane using a DRB. A single packet data network (PDN) connection is used to transport both IMS signaling and IMS voice, with IMS signaling transported using IP packets over a default bearer of the IMS PDN connection and IMS voice carried over a dedicated bearer of the IMS PDN connection. The PDN connection type for support of IMS voice over NB-IoT NTN is IP, and the UE IP address is allocated as part of the PDN connection establishment to the APN used for IMS voice and used by the UE 104 towards IMS during IMS registration. The destination IP address and UDP port to be used to send downlink voice traffic to the UE 104 are provided by the UE 104 to the IMS at IMS session-related signaling, and during the IMS session call setup procedure, the PDN gateway (P-GW) receives the downlink destination IP address and UDP port from the PCRF.

For transport of voice packets over the NB-IoT user plane, IP-based transport with RoHC is supported. Additionally, a non-IP transport mechanism is supported, wherein parts of RTP/UDP/IP headers are removed at the UE 104 and restored in the network. For non-IP transport, in the uplink direction, the UE 104 compresses or removes RTP header fields and removes UDP/IP headers, the P-GW or user plane function (UPF) restores UDP/IP headers based on addresses received from the PCRF during call setup, and an IMS access gateway (AGW) restores the compressed RTP fields. In the downlink direction, the AGW compresses RTP header fields, the P-GW or UPF removes UDP/IP headers, and the UE 104 restores both RTP and UDP/IP headers. A single UDP flow between the P-GW and the AGW per UE 104 is supported, and support for more than one simultaneous IMS voice call and multi-party calls is not required. Each non-IP datagram exchanged over the PDN connection corresponds to one and only one IP packet on the data network.

During dedicated evolved packet system (EPS) bearer establishment for IMS voice over NB-IoT NTN, if the P-GW decides to enable the non-IP mechanism, the P-GW instructs, via the serving gateway (S-GW), the mobility management entity (MME) to indicate to the eNB to not enable RoHC. The support of the non-IP mechanism to transport voice packets is optional for the UE 104, the P-GW, and the AGW. If a UE 104 supports the non-IP mechanism, the UE 104 supports both compress/restore RTP and remove/restore UDP/IP when transporting voice packets over an IP PDN connection. If a P-GW supports the non-IP mechanism, the P-GW supports remove/restore UDP/IP over an IP PDN connection for voice traffic based on Rx information received from the P-CSCF or PCRF. If an AGW supports the non-IP mechanism, the AGW supports compress/restore RTP and uses SDP IP addresses to transport voice traffic between the AGW and the P-GW. When accessing NB-IoT via GEO satellite, during a PDN connectivity procedure, the selected P-GW and selected P-CSCF may or may not support the non-IP mechanism, and if the PDN connection supports the non-IP mechanism, an indication is sent to the UE 104 via extended protocol configuration options (ePCO). During a voice call session setup procedure, if the PDN connection supports the non-IP mechanism, the UE 104 indicates its support of the non-IP mechanism to the P-CSCF in SDP information. If the P-CSCF decides to enable the use of the non-IP mechanism, the P-CSCF selects an AGW supporting the non-IP mechanism and indicates to the AGW to enable the use of the non-IP mechanism, indicates to the P-GW to enable the use of the non-IP mechanism, and indicates to the UE 104 via SDP information to enable the use of the non-IP mechanism. DTMF signaling is supported for IMS Voice over NB-IoT NTN, and the modified RTP header supports DTMF transport.

Although the preceding examples are described with reference to a UE 104, the techniques described herein are equally applicable to an NE 102 or any other node (e.g., IMS-AGW) or device capable of transmitting or receiving audio codec payloads, and the following descriptions and examples similarly apply to UEs, NEs, and so forth unless otherwise specified.

According to implementations, one or more of the NEs 102 and the UEs 104 are operable to implement various aspects of the techniques described with reference to the present disclosure. For example, a transmitting device or node (e.g., a UE 104, an NE 102) detects a DTMF event and substitutes a binary representation of the DTMF event into an audio codec payload. The transmitting node releases the audio codec payload to a lower layer for transmission. In the example of FIG. 1, an NE 102 transmits an audio codec payload 110 to a UE 104. The UE 104 transmits an audio codec payload 112 to the NE 102. The audio codec payloads 110 and 112 include substituted DTMF event binary representations as described herein. A receiving device or node (e.g., a UE 104, an NE 102) receives the audio codec payload, extracts the binary representation of the DTMF event from the audio codec payload, and forwards the audio codec payload to an audio decoder. The techniques described herein are applicable to both IP-based transport (e.g., RTP over UDP/IP) and non-IP transport (e.g., transport over a radio Layer-2 protocol).

To substitute the binary representation of the DTMF event into the audio codec payload, the transmitting node performs distributed bit puncturing on audio coded data in the audio codec payload to provide bit positions for the binary representation of the DTMF event. The node determines a puncturing mask indicating the bit positions based on a reliability pattern of the audio coded data. For example, the node selects a group of coded audio features based on the reliability pattern and selects a set of quantized bits of one or more of the coded audio features that are robust to puncturing. The node selects an interleaving pattern for the bit positions indicated by the puncturing mask and applies the interleaving pattern to interleave the bit positions with remaining bits of the audio coded data. The node then replaces bits at the bit positions indicated by the puncturing mask with the binary representation of the DTMF event.

In some examples, the binary representation of the DTMF event is prefixed to the audio codec payload to form a header extension included within a codec payload header of the audio codec payload. Presence of the binary representation of the DTMF event in the audio codec payload is indicated by a presence bit in the codec payload header. An end of the DTMF event is indicated by an end bit in the codec payload header. During silence periods when DTX is enabled and no audio coded data is available, the audio codec payload comprises the binary representation of the DTMF event as a DTMF-only payload, e.g., excluding audio coded data.

The binary representation of the DTMF event encodes or otherwise indicates a DTMF event identifier. As a non-limiting example, the binary representation comprises four bits encoding up to 16 different events, including digits 0 through 9, special characters * and #, and characters A through D. The capability to substitute the binary representation of the DTMF event into the audio codec payload is negotiated via an SDP offer-answer procedure. Additionally, or alternatively, a fixed duration for the DTMF event is negotiated via the SDP offer-answer procedure. Additionally, or alternatively, a default playback volume indication for the DTMF event is negotiated via the SDP offer-answer procedure.

The receiving node extracts the binary representation of the DTMF event from the audio codec payload. To do so, the receiving node recovers the binary representation from bit positions in the audio codec payload according to the puncturing mask. The receiving node performs error concealment on the audio codec payload based on the puncturing mask to mitigate any distortion introduced by the substituted DTMF bits. Alternatively, the receiving node reads the binary representation of the DTMF event from a header extension of the codec payload header. The receiving node forwards the audio codec payload to an audio decoder for decoding and playback. The audio decoder may be included as part of the receiving node or may be located elsewhere, e.g., as a separate component or as part of a different node.

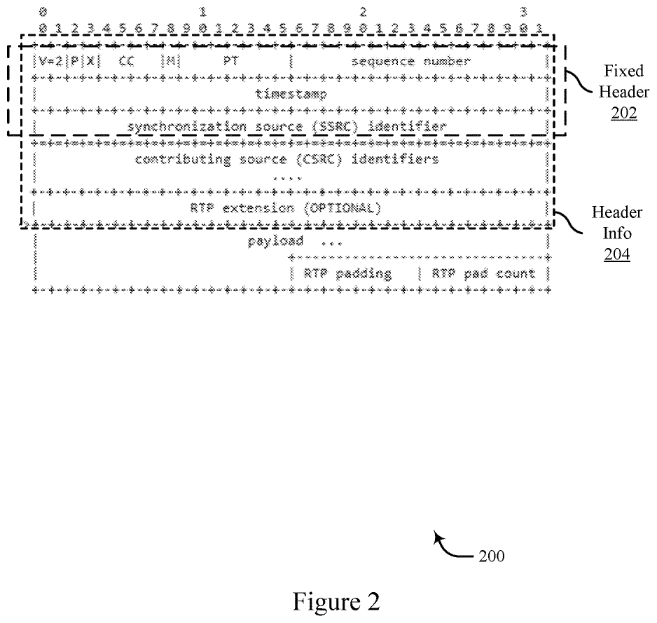

FIG. 2 illustrates an example RTP PDU 200 in accordance with aspects of the present disclosure. In some examples, the RTP PDU 200 implements or is implemented by aspects of the wireless communications system 100. For example, the RTP PDU 200 may be implemented by a UE and/or a NE, which may be examples of a UE 104 and a NE 102 as described with reference to FIG. 1.

An RTP packet or RTP PDU may be formed of an RTP header and an RTP payload, which may alternatively be referred to as an RTP service data unit (SDU). The RTP header may include a fixed header 202 containing the first 12 bytes of header information, additional header info 204 fields such as contributing source (CSRC) identifiers of media flows if available, and optional RTP extension header fields. In simpler formats, such as those used in IMS Voice, the RTP header may be of a fixed size (e.g., 12 bytes).

The fixed header 202 of the RTP PDU may comprise the following fields. A version field (V) of 2 bits may indicate the RTP PDU syntax version, which may be fixed to a value of 2. A padding field (P) of 1 bit may indicate whether padding of the payload is applied to the RTP PDU. An extension field (X) of 1 bit may indicate whether the standard fixed RTP header will be followed by an RTP header extension, which may be associated with a particular data or profile and may carry additional information about the payload. A CSRC count field (CC) of 4 bits may indicate the number of contributing media sources (CSRC) that follow the fixed header 202. A marker field (M) of 1 bit may be intended to mark information regarding frame boundaries in the packet stream, the behavior of which may be specified by RTP profiles or codec payloads. In audio codecs such as AMR-WB and EVS, the marker field may be used to indicate the first voiced frame after a silence period, signaling a start of a talkspurt. A payload type field (PT) of 7 bits may indicate the payload type corresponding to a media representation (e.g., codec and/or codec mode), which may be dynamically negotiated via an SDP offer-answer procedure (e.g., 96 for AMR-WB, 97 for EVS). A sequence number field of 16 bits may indicate a sequence number that increments by one with each RTP data packet sent over a session. A timestamp field of 32 bits may indicate a timestamp in ticks of the payload type clock reflecting the sampling instant of the first octet of the RTP data packet. The first timestamp of the first RTP packet may be selected at random, and in the case of audio, the audio bandwidth may determine the clock rate associated with the payload type (e.g., 16000 for AMR-WB or EVS in wideband mode, 8000 for AMR or EVS in narrowband mode). A synchronization source (SSRC) identifier field of 32 bits may indicate a random identifier for the source of a stream of RTP packets forming a part of the same timing and sequence number space, such that a receiver may group packets based on synchronization source for playback. In the case of a single RTP session with a single media source and stream, the SSRC identifier may correspond to a fixed value that is randomly initialized.

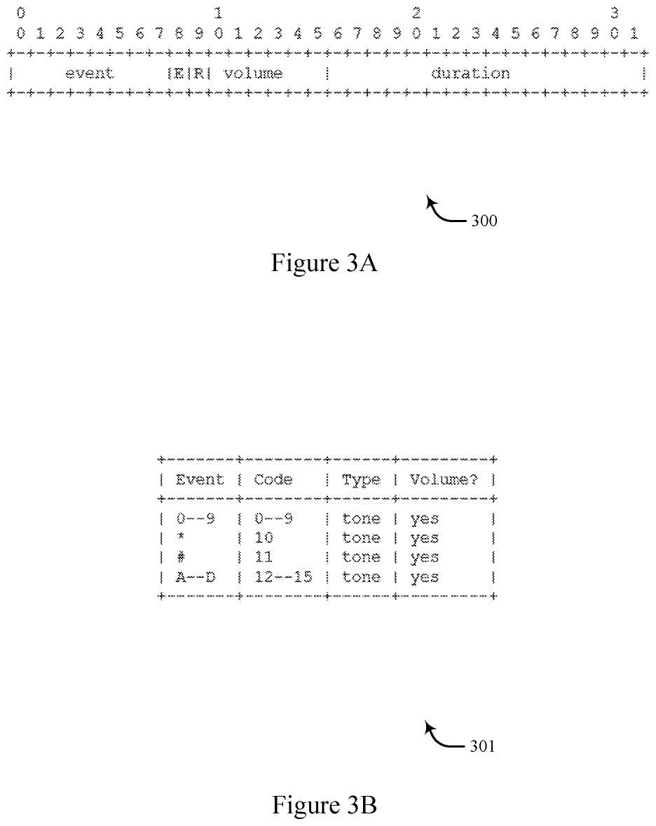

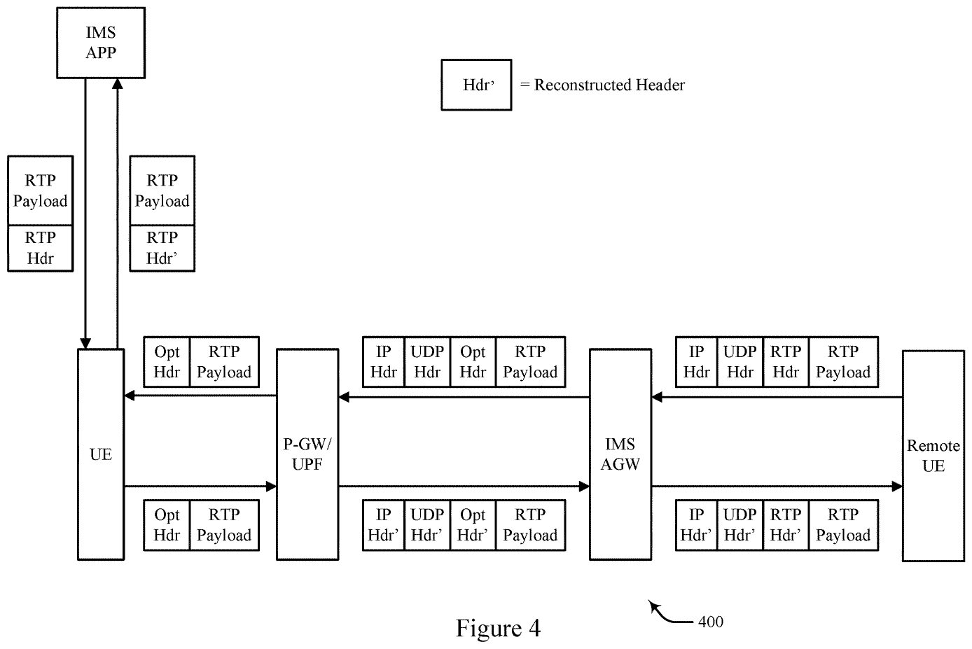

FIG. 3A illustrates an example RTP payload format 300 for DTMF telephony events in accordance with aspects of the present disclosure. In some examples, the RTP payload format 300 implements or is implemented by aspects of the wireless communications system 100. For example, the RTP payload format 300 may be implemented by a UE and/or a NE, which may be examples of a UE 104 and a NE 102 as described with reference to FIG. 1. Additionally, or alternatively, the RTP payload format 300 may be encapsulated within an RTP PDU as described with reference to FIG. 2.

DTMF may be transported during a call session in three ways. In a first approach, a transmitter (e.g., a transmitting device, a transmitting node) transports DTMF events out-of-band in the media plane, as separate RTP payloads multiplexed with the audio RTP packets, i.e., named telephone events. This is the most common approach in deployed systems. In a second approach, the transmitter transports DTMF events in-band in the media plane, wherein the DTMF tones are treated as audio and encoded directly into the audio codec bitstream after being passed through the encoder. To access the DTMF tones using this approach, a receiver (e.g., a receiving device, a receiving node) must decode the audio bitstream and play it back. In a third approach, the transmitter transports DTMF events via SIP INFO messages in the signaling plane. This approach is rarely used in practice given the loss of synchronization between audio and the DTMF events, as the SIP messages may arrive de-synchronized from the audio given the different transport path.

Two types of DTMF RTP payload formats may be used: telephone events (e.g., a user pressing one of the buttons such as 0-9, *, or #during a call) and tones (e.g., ringing tone, busy tone). In IMS Voice, tones are generated locally at the terminals and are not transmitted over the air. For example, when a SIP 180 (Ringing) message is received, a ringing tone may be generated locally, and when a SIP 486 (Busy Here) message is received, a busy tone may be generated locally. As a consequence, in IMS Voice, active support of telephone events is sufficient.

Telephone events have an RTP payload size of 4 bytes. The DTMF telephony event payload may comprise the following fields. An event field of 8 bits may identify the telephony event. An end of event field (E) of 1 bit may be set only in the last packet corresponding to a set of packets that span a long-lasting event. The last packet may be recommended to be sent three times for increased reliability to ensure that the end of event is more likely captured and not lost due to congestion or bad link conditions. A reserved field (R) of 1 bit may be reserved for future use. A volume field of 6 bits may describe the power level of the tone, expressed in relative units to 0 dBm, spanning values from 0 to −63 dBm 0 (the sign may be implicitly dropped in signaling). The volume field may apply for tones that support variable volume. In real-world deployments of VoIP such as IMS Voice, the volume field of the DTMF digits may be ignored in the network or at the receiver, since the receiver terminal may be responsible for generating the corresponding tone itself. Hence, the signaling may be of the event itself rather than its analog or playback audio characteristics. A duration field of 16 bits may indicate the duration in timestamp units of the event reported. When set (i.e., non-zero), the event may have begun at the instant of the RTP timestamp and may have lasted as long as indicated by this value. The event may or may not have ended. When the 16-bit value overruns, an event may be split over multiple packets or segments.

FIG. 3B illustrates an example of DTMF telephony event codepoints 301 in accordance with aspects of the present disclosure. In some examples, the DTMF telephony event codepoints 301 implements or is implemented by aspects of the wireless communications system 100. For example, the DTMF telephony event codepoints 301 may be utilized by a UE and/or a NE, which may be examples of a UE 104 and a NE 102 as described with reference to FIG. 1. The DTMF telephony event codepoints 301 may correspond to the event field of the RTP payload format as described with reference to FIG. 3A.

The DTMF telephony event codepoints may include digits 0 through 9 mapped to codes 0 through 9, the asterisk character (*) mapped to code 10, the hash character (#) mapped to code 11, and letters A through D mapped to codes 12 through 15. All of these events may be of type tone and may support variable volume. Additional DTMF telephony events beyond these may be registered, yet the DTMF digits may be sufficient for legacy digit-based IVR systems and may cover most deployed use cases. DTMF telephony events may not be frequently transmitted, as transmission may happen only once a user presses a button. The telephony event may overlap with either voiced frames or with silence (e.g., SID frames at the RTP layer). When a user presses a button, one or more DTMF packets may be transmitted spread over the duration of the event. When multiple packets are transmitted, the marker bit (M) in the RTP header may indicate the first packet, and the end bit (E) in the DTMF telephony event may indicate the end.

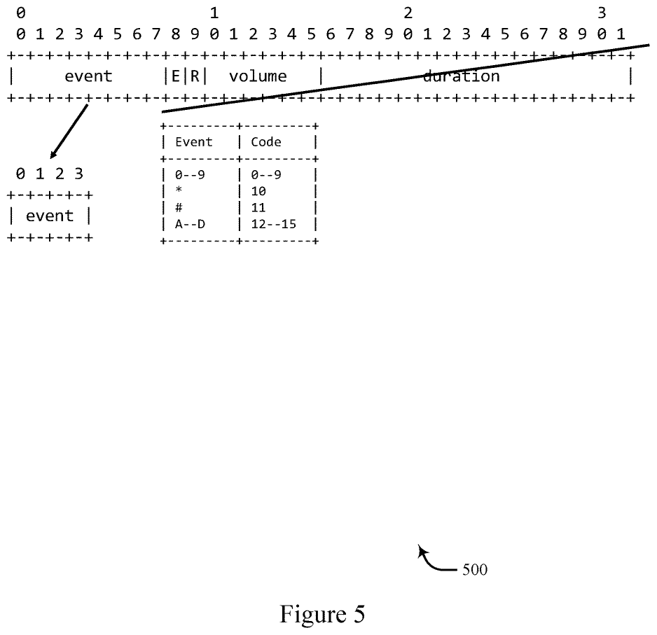

FIG. 4 illustrates an example non-IP transport architecture 400 for IMS Voice in accordance with aspects of the present disclosure. In some examples, the non-IP transport architecture 400 implements or is implemented by aspects of the wireless communications system 100. For example, the non-IP transport architecture 400 can implement aspects of, or can be implemented by, a UE and/or a NE, which may be examples of a UE 104 and a NE 102 as described with reference to FIG. 1.

When the optional non-IP mechanism is negotiated between a UE 104, a P-GW, and an access gateway (AGW), voice packets may traverse the radio link without UDP/IP headers. In the uplink direction, the UE 104 may compress or remove RTP header fields and may strip UDP/IP headers entirely. The P-GW may restore UDP/IP headers using addresses exchanged during call setup via the PCRF. The AGW may restore the compressed RTP fields. In the downlink direction, the AGW may compress RTP header fields and may send the compressed packets via UDP/IP to the P-GW. The P-GW may strip UDP/IP headers before forwarding the packets over the radio link. The UE 104 may then restore both RTP and UDP/IP headers internally. This may yield a single non-IP datagram per voice packet over the air interface, with each datagram containing only a compressed RTP header plus payload.

Ensuring that DTMF digit events (e.g., digits 0-9, special characters * and #, and letters A-D) do not disturb voice service may be important in narrowband communications such as NB-IoT NTN over GEO access. The techniques described herein may carry the DTMF digit events within the codec payload, leveraging a small portion (e.g., a few bits) of the codec payload by puncturing the audio coded data and/or utilizing a few bits in the codec payload. This may take advantage of the ability of modern neural codecs, as well as traditional codecs, to cope with a few bit errors (e.g., 2-4 bits) when designed with robust encoding of audio features and/or quantization methods. This approach may be equally applicable to both IP-based transport and non-IP transport.

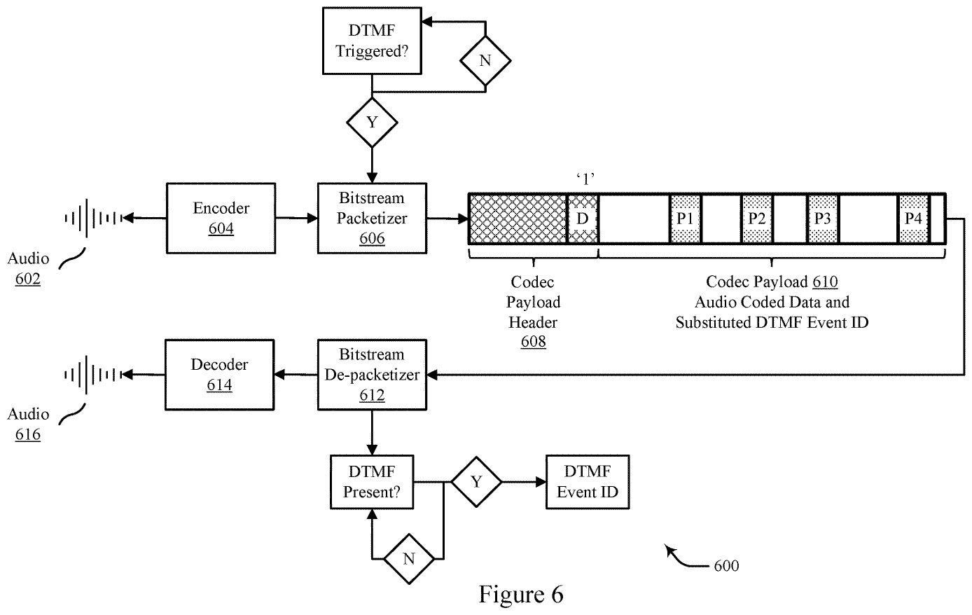

FIG. 5 illustrates an example reduced DTMF event representation 500 in accordance with aspects of the present disclosure. In some examples, the reduced DTMF event representation 500 implements or is implemented by aspects of the wireless communications system 100. For example, the reduced DTMF event representation 500 may be implemented by a UE and/or a NE, which may be examples of a UE 104 and a NE 102 as described with reference to FIG. 1. The reduced DTMF event representation 500 may be derived from the RTP payload format as described with reference to FIG. 3A and may utilize the DTMF telephony event codepoints as described with reference to FIG. 3B.

In some implementations, a DTMF event may be reduced to an identifier codepoint of the event. For VoIP, digital IVR systems, and DTMF-based telephony services, the duration and volume of DTMF events (e.g., digits 0-9, special characters * and #, and less commonly letters A-D) may not particularly matter, as the only relevant aspect may be the event identifier. As such, the details of event end, volume, and duration of the defined DTMF RTP payload may be stripped and recomposed at a receiver (e.g., an IVR system). As illustrated in FIG. 5, the RTP payload of a DTMF event may be reduced to a 4-bit width codepoint identifying digits 0-9 and special characters * and #, as well as letters A-D. In some implementations, to maintain backwards compatibility with existing DTMF-based applications and systems, the DTMF event identifier codepoints may be preserved. Accordingly, in some examples, the binary representation of the DTMF event may encode a DTMF event identifier, and the binary representation may comprise four bits encoding up to 16 different events.

For digital IVR systems and automated answering applications, the receiver may only need to know which button was pressed. The volume field of the DTMF RTP payload was used for analog telephony systems and may no longer be relevant for digital systems. The duration may be tracked at the receiver side if needed. The end bit (E) may optionally be retained to indicate that the DTMF event has concluded, which may be useful for redundancy or increased reliability purposes, such as repeated transmission of the same event to ensure delivery. The binary representation of the DTMF event may additionally encode at least an end marker indicating the end of the DTMF event.

By reducing the DTMF event representation to a small number of bits (e.g., 4 bits), the reduced representation may be substituted into the audio codec payload with minimal impact. For example, the reduced representation may be embedded by puncturing a small number of bit positions (e.g., at most 4 bits) in the audio coded data, which modern neural codecs and traditional codecs may tolerate with minimal perceptual degradation. Alternatively, the reduced representation may be included as a header extension within the codec payload header, adding only a small number of additional bits (e.g., approximately 4 bits) to the codec payload. This reduction from a 4-byte (32-bit) DTMF RTP payload to a 4-bit binary representation may provide significant bandwidth savings in ultra-low bit rate scenarios such as IMS Voice over GEO satellite, where link capacities may be within the range of 1-3 kbps.

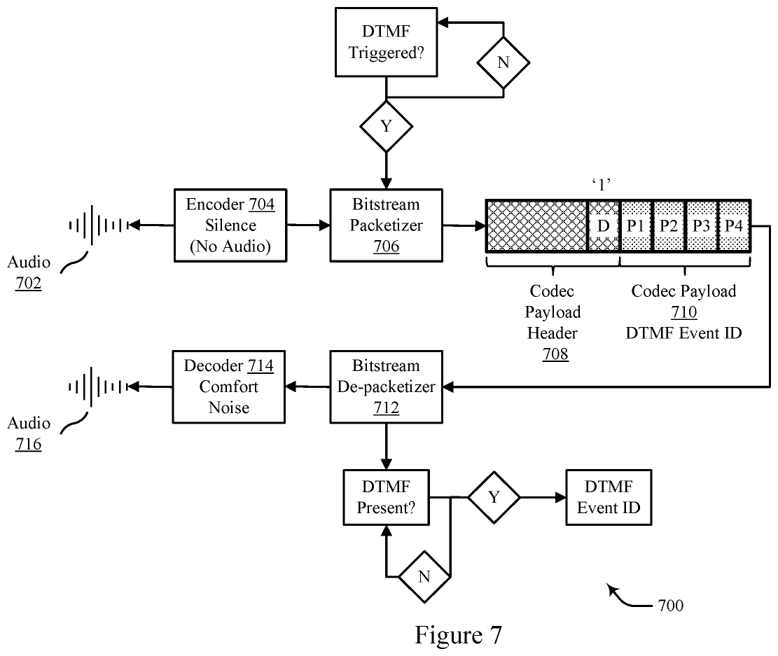

FIG. 6 illustrates an example signal processing flow 600 for substituting a DTMF event into an audio codec payload in accordance with aspects of the present disclosure. In some examples, the signal processing flow 600 implements or is implemented by aspects of the wireless communications system 100. For example, the signal processing flow 600 can implement aspects of, or can be implemented by, a UE and/or an NE, which may be examples of a UE 104 and an NE 102 as described with reference to FIG. 1. The signal processing flow 600 may utilize the reduced DTMF event representation as described with reference to FIG. 5.

A node implementing the signal processing flow 600 may operate as a transmitting node on the encoding side or as a receiving node on the decoding side. For example, a UE 104 or an NE 102 operating as a transmitting node may detect a DTMF event, substitute a binary representation of the DTMF event into an audio codec payload, and release the audio codec payload to a lower layer for transmission. Conversely, a UE 104 or an NE 102 operating as a receiving node may receive an audio codec payload, extract a binary representation of a DTMF event from the audio codec payload, and forward the audio codec payload to an audio decoder.

On the encoding side, audio 602 may enter an encoder 604. The encoder 604 may process the audio 602 and may output encoded audio data to a bitstream packetizer 606. When a DTMF event is triggered (e.g., a user presses a button on a telephone keypad), the bitstream packetizer 606 may generate a packet structure comprising a codec payload header 608 and a codec payload 610 containing audio coded data with a substituted DTMF event identifier. The codec payload header 608 may include a presence bit (D) set to 1 indicating that a DTMF event is present. The codec payload 610 may include bit positions P1, P2, P3, and P4 where the binary representation of the DTMF event is substituted into the audio coded data.

The DTMF event reduced representation may be substituted into the audio coded data by puncturing a few bits (e.g., at most 4 bits) of the coded audio. The position of the punctured bits may be fixed, non-contiguous, and interleaved with remaining bits of the coded audio to form a new bitstream multiplexing in-band coded audio with DTMF events. The puncturing positions may be determined based on a reliability pattern of the audio coded data. A reliability pattern refers to a characterization of which bits or groups of bits in the audio coded data are more tolerant to errors or modifications without significantly degrading the reconstructed audio quality. The reliability pattern may be determined based on an applied quantizer in the coded audio domain, the quantizer discretizing a latent representation of the coded audio. A latent representation refers to an intermediate, compressed representation of the audio signal produced by the encoder, where the audio characteristics are encoded into a set of numerical values (latents) that capture the essential features of the audio in a compact form.

In some implementations, some of the latent representation may include redundancy (e.g., non-uniform redundancy or statistically correlated latents) and may be more robust to puncturing. Robustness to puncturing refers to the ability of certain bits or latents to be modified or replaced without causing significant perceptual degradation in the decoded audio, due to inherent redundancy or error tolerance in how those bits contribute to the final audio reconstruction. In such cases, latents with higher robustness to puncturing may be punctured first. The puncturing may be performed in a fixed, round-robin fashion, freeing bits across one or more latents, or alternatively a set of latents, as necessary. In other implementations, latents or groups of latents may have the same robustness to puncturing (e.g., uniform redundancy or statistically uncorrelated latents), yet by nature of the quantization, some bits of their discrete representation may be less impacted than others by errors or puncturing when performing inverse quantization back to the latent domain. For example, in a Gray coded uniform quantizer, the least significant bits may be flipped or punctured with less impact on recovered signal-to-noise ratio (SNR) than more significant bits.

In some implementations, the puncturing strategy may first group the latents and select a group comprising the most robust latents to puncturing. The group may correspond to a robust channel features set. Channel features refer to the encoded characteristics of the audio signal, such as spectral information, pitch, or energy levels, that are represented in the coded bitstream. A robust channel features set comprises those features that are less sensitive to bit errors and can tolerate puncturing with minimal impact on perceived audio quality. For each of the latents in the robust channel features set, one or more of the least significant bits may be selected for puncturing to determine and fix the puncturing positions. The set of quantized bits may contain one or more bits. The set of quantized bits may comprise a least significant bit or a most significant bit. Alternatively, the set of quantized bits may comprise a bit with high reliability or a bit with low resolution or low impact for audio perceptual quality. The coded audio features may comprise audio latent feature representations, or alternatively audio latent features. The reliability pattern may include audio latent features with increased robustness to errors. The puncturing positions may output a puncturing mask, the puncturing mask useful for both the encoder 604 and a decoder 614 for substituting and recovering DTMF events in and from the bitstream. The puncturing positions may be subsequently punctured to yield bit positions that may be replaced (e.g., XORed) with the bits of the reduced DTMF event representation. The output corresponds to an audio coded bitstream with substituted DTMF events.

When puncturing is applied, the presence bit (D) in the codec payload header 608 may be set (e.g., D=1) indicating that DTMF events are present, instructing the receiver to first determine the DTMF event by reading the punctured positions according to the puncturing mask and then performing audio decoding. Audio decoding may be further optimized by error concealment to mitigate potential errors from the DTMF substituted signals onto the recovered latent codec representation after quantization.

From a rate-distortion theory perspective, even with lossy compression, puncturing 1-2 bits may introduce additional distortion but may not fundamentally collapse the coder system. Neural codecs may be designed so that punctured positions correspond to redundant or less critical information. On average, the distribution of bits at punctured positions means the decoder may have some bits correct and some in error, lowering the average number of erroneous bits. At ultra-low bit rates such as 1 kbps with a 20-80 ms frame period, there may be approximately 20-80 bits per frame, so achieving approximately 5% bit error rate may allow recovery with relatively low, or alternatively, low distortion.

On the decoding side, a bitstream de-packetizer 612 may receive the codec payload 610 and may check the presence bit (D) in the codec payload header 608. If DTMF is present (D=1), the DTMF event identifier may be extracted from the punctured positions using the puncturing mask. The receiver may know the positions of the punctured bits since both the transmitter and receiver may operate in sync (e.g., operating in the same mode), so the receiver may apply the mask and recover the DTMF event. The bitstream de-packetizer 612 may forward the audio coded data to the decoder 614, which may decode and output audio 616. The decoder 614 may perform error concealment to mitigate potential errors at the bit positions P1, P2, P3, and P4 where the DTMF bits were substituted. The decoder 614 may receive the audio coded frame and may decode with the punctured bits corresponding to the embedded DTMF event. Potential bit errors at positions P1, P2, P3, and P4, representing deltas between bits output by the encoder 604 and bits received by the decoder 614, may be reconciled by internal logic of the decoder 614 to generate an audio representation for playback (e.g., pulse-code modulation (PCM) or similar). The DTMF event identifier may be processed in parallel with the audio coded data depending on the audio service.

In some implementations, the techniques described herein may be applicable to both UEs 104 and network elements (e.g., NEs 102). For example, for interoperability with existing codecs, transcoding may be performed in the network. A network element (e.g., an NE 102) may decode an audio codec payload containing a substituted DTMF event binary representation and may translate the DTMF event into a conventional DTMF RTP payload for delivery to a remote device that does not support the embedded DTMF approach. The telephony events that are supported may be negotiated and exchanged during the IMS call setup, such that each party may know what events are supported.

FIG. 7 illustrates an example signal processing flow 700 for substituting a DTMF event into an audio codec payload during a silence period in accordance with aspects of the present disclosure. In some examples, the signal processing flow 700 implements or is implemented by aspects of the wireless communications system 100. For example, the signal processing flow 700 can implement aspects of, or can be implemented by, a UE and/or an NE, which may be examples of a UE 104 and an NE 102 as described with reference to FIG. 1. The signal processing flow 700 may utilize the reduced DTMF event representation as described with reference to FIG. 5 and may represent an alternative to the signal processing flow as described with reference to FIG. 6 for silence periods when DTX is enabled.

Similar to the signal processing flow 600 described with reference to FIG. 6, a node implementing the signal processing flow 700 may operate as a transmitting node on the encoding side or as a receiving node on the decoding side. For example, a UE 104 or an NE 102 operating as a transmitting node may detect a DTMF event during a silence period, substitute a binary representation of the DTMF event into an audio codec payload as a DTMF-only payload, and release the audio codec payload to a lower layer for transmission. Conversely, a UE 104 or an NE 102 operating as a receiving node may receive an audio codec payload containing a DTMF-only payload, extract a binary representation of a DTMF event from the audio codec payload, and forward the audio codec payload to an audio decoder.

In some implementations, a DTMF event may be triggered during silence periods when DTX is enabled. On the encoding side, audio 702 may enter an encoder 704. When a VAD routine detects silence in the audio 702, the encoder 704 may not produce audio coded frames. The encoder 704 may indicate to the bitstream packetizer 706 that no audio is to be sent. The bitstream packetizer 706 may output packets compliant with the audio codec payload, yet without any audio coded representation (i.e., empty audio packets). The empty audio packets may still carry the DTMF event identifier in a contiguous block of bits as a DTMF-only payload. The codec payload header 708 may include a presence bit (D) set to 1indicating that a DTMF event is present. The codec payload 710 may include positions D, P1, P2, P3, and P4 representing the DTMF event identifier bits, forming a DTMF-only payload without audio coded data. Accordingly, the audio codec payload may comprise the binary representation of the DTMF event as a DTMF-only payload excluding audio coded data.

On the decoding side, the bitstream de-packetizer 712 may receive the codec payload and may check the presence bit (D) in the codec payload header 708. If DTMF is present (D=1), the DTMF event identifier may be extracted and forwarded for processing. The lack of audio coded frames may be determined at the decoder 714 based on the length of the payload of the received packet, thus bypassing the decoder 714 for audio decoding and only extracting the DTMF event identifier. The decoder 714 may continue to operate according to its current state, or alternatively, may generate comfort noise. The bitstream de-packetizer 712 may indicate to the decoder 714 that no audio was sent, and the decoder 714 may output audio 716 comprising comfort noise or may maintain its previous state.

During a voice call, silence periods may occur frequently (e.g., when one party is listening while the other speaks). During these silence periods, a user may still press buttons on the telephone keypad to interact with an IVR system. Since the encoder 704 may not be producing audio coded frames during silence, the DTMF event may be carried as a DTMF-only payload without the need to puncture audio coded data. This may simplify the processing at both the transmitter and receiver, as no puncturing mask is needed and no error concealment is required at the decoder 714.

In some implementations, a DTMF event may be transmitted multiple times for increased reliability. For example, the same DTMF event identifier may be sent in consecutive packets to ensure that the event is captured even if one or more packets are lost due to congestion or bad link conditions. The node may repeat the substitution of the binary representation of the DTMF event into two or more distinct audio codec payloads. The repetitions in two or more audio codec payloads may result in two or more distinct audio coded packets being released for transmission to lower layers. Repetitions of the audio codec payload may improve DTMF event detection reliability at a receiver node.

The end bit (E) may be used, in some implementations, to indicate the conclusion of the DTMF event. The end bit ‘E’ set (e.g., E=1) indicates the DTMF has ended with the corresponding packet or earlier. In some examples, the end bit ‘E’ may be signaled as part of the codec payload by puncturing (i.e., substituting) another bit position, such as at the end of the codec payload or alternatively, in the codec payload header (e.g., together with the DTMF event ‘D’ indicator). The last packet of the event may be sent multiple times (e.g., two or three times) with the end bit set, consistent with reliability practices for DTMF transport. The receiver may receive the same event identifier multiple times and may extend the duration of the event on the receiver side, or if the end bit marking is received, the receiver may stop the event.

In some implementations, a fixed duration for the DTMF event may be negotiated via an SDP offer-answer procedure. When a fixed duration is negotiated, the first time the DTMF event is captured at the receiver, the event may be auto-cancelled by the receiver within the negotiated duration (e.g., 120 or 160 ms). This may provide an alternative to using the end bit (E) for indicating event conclusion. Even if the end bit is not received or a packet is lost, the event may cancel itself after the negotiated duration. This approach may minimize overhead by avoiding the need to transmit the end bit while still providing reliable DTMF event delivery. The SDP attribute for the capability to substitute the binary representation of the DTMF event into the audio codec payload may also indicate the fixed duration.

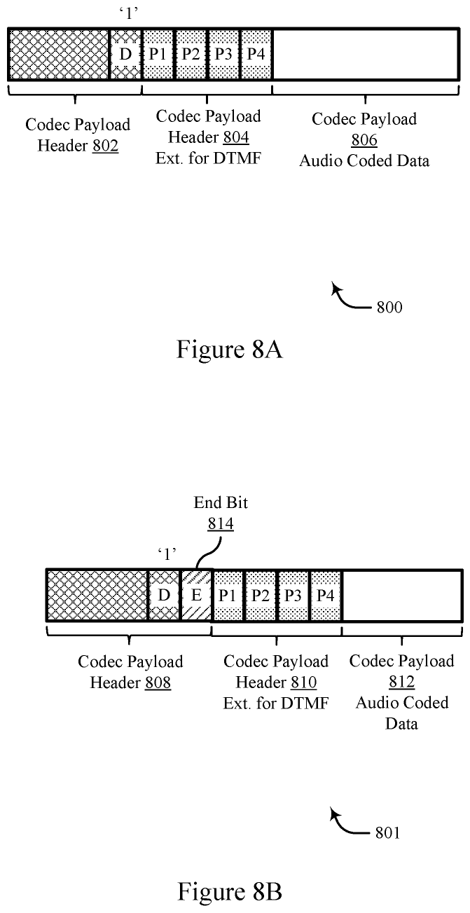

FIG. 8A illustrates an example audio codec payload structure 800 in accordance with aspects of the present disclosure. In some examples, the audio codec payload structure 800 implements or is implemented by aspects of the wireless communications system 100. For example, the audio codec payload structure 800 may be implemented by a UE and/or a NE, which may be examples of a UE 104 and a NE 102 as described with reference to FIG. 1. The audio codec payload structure 800 may be generated by the signal processing flows as described with reference to FIGS. 6 and 7.

In some implementations, the DTMF event reduced representation may be substituted within a codec payload header extension. The codec payload header extension may be optionally present when the presence bit D is set (e.g., D=1), and otherwise (D=0) it may be absent. Instead of interleaved, punctured substitution of the DTMF event codepoint with the audio coded frame, the DTMF event representation may be appended to the codec payload header just before the audio coded frame.

The codec payload header 802 may include a presence bit D. The codec payload header 804 extension for DTMF may include fields P1, P2, P3, and P4 representing bit positions for the binary representation of the DTMF event. The codec payload 806 may contain the audio coded data. The excess number of bits (e.g., 4 bits for 16 DTMF events) may be sufficiently small to not consume too much of the available bit rate for audio even in very narrowband communications. Since the audio coded frame is transmitted in full (without puncturing) as released by the encoder, the decoder does not have to apply error concealment techniques and no impairment beyond normal operation at a given bitrate is expected from an audio quality perspective. In some implementations, the audio coded data may be packed such that the base rate or most critical information is at the beginning, and fine details at the end. The fine detail bits may be pruned and the DTMF bits may be placed as a header extension, giving away a small number of bits (e.g., 3-4 bits) of audio coded data for use by DTMF events.

The header extension approach described with reference to FIG. 8A may provide an alternative to the puncturing approach described with reference to FIG. 6. With the puncturing approach, the binary representation of the DTMF event is substituted at interleaved bit positions within the audio coded data, adding no additional overhead but relying on error concealment at the decoder to mitigate distortion at the punctured positions. With the header extension approach, the binary representation of the DTMF event is appended to the codec payload header as an extension, adding a small number of additional bits (e.g., approximately 4 bits) but preserving the audio coded data in full as released by the encoder. On the decoding side, a receiving node may read the binary representation of the DTMF event from the header extension of the codec payload header when the presence bit D is set (e.g., D=1), and may forward the audio codec payload to an audio decoder without requiring error concealment for the DTMF substitution. The choice between the two approaches may depend on application requirements. For example, the puncturing approach may be preferred when minimizing overhead is prioritized, while the header extension approach may be preferred when preserving audio quality is prioritized. Whether puncturing or header extension is used, the high-level concept is the same: a small number of bits (e.g., 3-4 bits) of audio coded data are given away for use by DTMF digit events. Whether the DTMF bits are interleaved with the audio coded data (puncturing) or prepended or appended to the audio coded data as a header extension is a matter of design.

FIG. 8B illustrates an example audio codec payload structure 801 with an end bit in accordance with aspects of the present disclosure. In some examples, the audio codec payload structure 801 implements or is implemented by aspects of the wireless communications system 100. For example, the audio codec payload structure 801 may be implemented by a UE and/or a NE, which may be examples of a UE 104 and a NE 102 as described with reference to FIG. 1. The audio codec payload structure 801 may be an extension of the audio codec payload structure as described with reference to FIG. 8A, including an end bit for indicating DTMF event conclusion.

FIG. 8B is similar to FIG. 8A but includes an end bit 814 (E) in the codec payload header 808, the end bit indicating whether the DTMF event has concluded. The codec payload header 808 may further include a presence bit D. The codec payload header 810 extension for DTMF may include fields P1, P2, P3, and P4. The codec payload 812 may contain audio coded data. The end bit 814 (E) may indicate whether the DTMF event has concluded. The end bit may complement the presence bit D in the codec payload header for redundancy or increased reliability purposes (e.g., repeated transmission of the same event). In implementations pertaining to silence detected or no audio to be transmitted, the same packet syntax and semantics as described with reference to FIG. 7 may be applicable, where the DTMF event codepoint is part of the codec payload header as an extension and the codec payload is empty.

The reliability mechanisms described with reference to FIG. 7 may also apply to the audio codec payload structures of FIGS. 8A and 8B. For example, the same DTMF event identifier may be transmitted in consecutive packets for increased reliability. The end bit 814 (E) in FIG. 8B may be sent multiple times (e.g., two or three times) to ensure that the end of the DTMF event is captured. Additionally, a fixed duration for the DTMF event may be negotiated via an SDP offer-answer procedure, providing an auto-cancel mechanism as an alternative to the end bit.

In some implementations, the header extension approach may be combined with an embedded multi-rate coder. An embedded multi-rate coder may organize the audio coded data such that the most critical information for reconstructing a base version of the audio is positioned at the beginning of the audio coded data, while finer details are positioned toward the end. By pruning the least critical bits at the end of the audio coded data, the freed bit positions may be used for the DTMF header extension. This pruning approach may result in a slight reduction in audio fidelity for the fine details, but the base reconstruction of the audio may remain intact.

The methods for substituting the reduced DTMF event representation into the codec payload may apply to IP-based transport (e.g., codec packets encapsulated into RTP as an RTP payload and transported over UDP/IP) and to non-IP based transport (e.g., codec payload encapsulated by an RTP optimized header with reduced size and/or function, transported via non-IP over the radio access network). The reduced DTMF event representation substitution into the codec payload is a codec capability and payload type attribute that may be negotiated between sender and receiver in an SDP offer-answer negotiation at call or session setup. The attribute determining the enablement of such a capability may instruct the coder and decoder to perform the described methods for substituting DTMF into the codec payload whenever a DTMF event is triggered. To enable such capability, the attribute may be offered in an SDP offer by the caller (e.g., a first UE 104) and acknowledged by the callee in the SDP answer. In some implementations, enabling this capability may apply bi-directionally during a call to a terminal for both outgoing and incoming audio frames. For example, the SDP attribute may be named ‘a=embed-DTMF’ and may be enabled (embed-DTMF=1) or disabled (embed-DTMF=0) by means of the SDP offer-answer procedure.

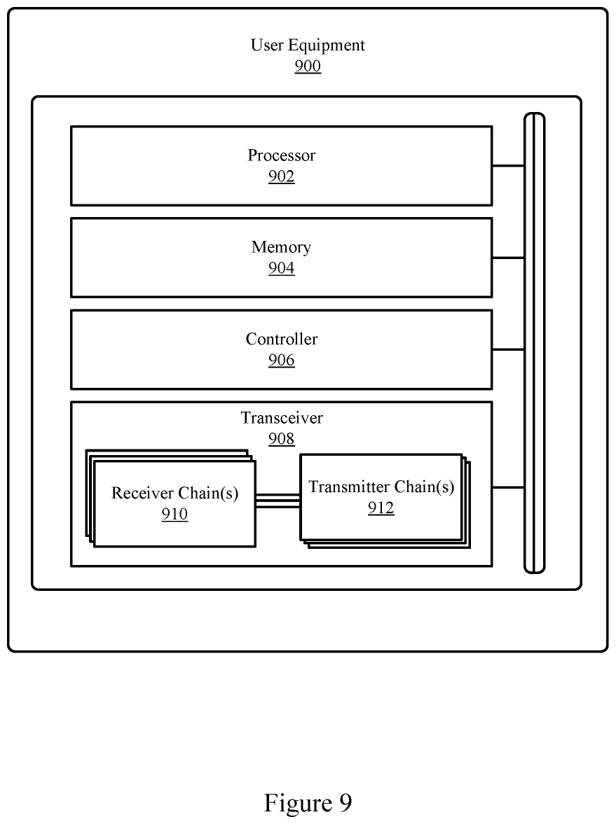

FIG. 9 illustrates an example of a UE 900 in accordance with aspects of the present disclosure. The UE 900 may include a processor 902, a memory 904, a controller 906, and a transceiver 908. The processor 902, the memory 904, the controller 906, or the transceiver 908, or various combinations thereof or various components thereof may be examples of means for performing various aspects of the present disclosure as described herein. These components may be coupled (e.g., operatively, communicatively, functionally, electronically, electrically) via one or more interfaces.

The processor 902, the memory 904, the controller 906, or the transceiver 908, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 902 may include an intelligent hardware device (e.g., a general-purpose processor, a DSP, a central processing unit (CPU), an ASIC, a field-programmable gate-array (FPGA), or any combination thereof). In some implementations, the processor 902 may be configured to operate the memory 904. In some other implementations, the memory 904 may be integrated into the processor 902. The processor 902 may be configured to execute computer-readable instructions stored in the memory 904 to cause the UE 900 to perform various functions of the present disclosure.

The memory 904 may include volatile or non-volatile memory. The memory 904 may store computer-readable, computer-executable code including instructions when executed by the processor 902 cause the UE 900 to perform various functions described herein. The code may be stored in a non-transitory computer-readable medium such as the memory 904 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 902 and the memory 904 coupled with the processor 902 may be configured to cause the UE 900 to perform one or more of the functions described herein (e.g., executing, by the processor 902, instructions stored in the memory 904). For example, the processor 902 may support wireless communication at the UE 900 in accordance with examples as disclosed herein. The UE 900 may be configured to or operable to support a means for detecting a DTMF event, substituting a binary representation of the DTMF event into an audio codec payload, and releasing the audio codec payload to a lower layer for transmission. In this manner, the UE 900 supports efficient DTMF transport by embedding DTMF event information directly into the audio codec payload rather than transmitting separate DTMF packets, reducing overhead and conserving bandwidth in bandwidth-constrained communications such as IMS Voice over GEO satellite. Substituting the binary representation of the DTMF event into an audio codec payload may comprise embedding the binary representation of the DTMF event into the audio codec payload, in place, without performing audio coding of the DTMF event.

Additionally, or alternatively, the UE 900 may be configured to support any one or combination of performing distributed bit puncturing on audio coded data in the audio codec payload to provide bit positions for the binary representation of the DTMF event. This aspect enables the DTMF event to be carried without adding additional overhead to the audio codec payload, as the DTMF bits replace existing audio coded data bits at punctured positions. Additionally, or alternatively, the UE 900 may be configured to support any one or combination of determining a puncturing mask indicating the bit positions, where determining the puncturing mask includes selecting a group of coded audio features based on a reliability pattern of the audio coded data, and selecting, based on the reliability pattern, a set of quantized bits of one or more of the coded audio features. This aspect minimizes perceptual impact on decoded audio quality by selecting bit positions that are robust to errors for puncturing. The set of quantized bits may contain one or more bits. The set of quantized bits may comprise a least significant bit or a most significant bit. Alternatively, the set of quantized bits may comprise a bit with high reliability or a bit with low resolution or low impact for audio perceptual quality. The coded audio features may comprise audio latent feature representations, or alternatively audio latent features. The reliability pattern may include audio latent features with increased robustness to errors.

Additionally, or alternatively, the UE 900 may be configured to support any one or combination of selecting an interleaving pattern for the bit positions indicated by the puncturing mask, and applying the interleaving pattern to interleave the bit positions with remaining bits of the audio coded data. This aspect distributes the punctured bits across the audio coded data to reduce localized distortion and improve error resilience. Additionally, or alternatively, the UE 900 may be configured to support any one or combination of substituting the binary representation of the DTMF event includes replacing bits at the bit positions indicated by the puncturing mask with the binary representation of the DTMF event. This aspect provides a mechanism for embedding the DTMF event identifier into the audio coded data without requiring additional header overhead.

Additionally, or alternatively, the UE 900 may be configured to support any one or combination of presence of the binary representation of the DTMF event in the audio codec payload being indicated by a presence bit. This aspect enables a receiving node to determine whether DTMF event information is present in the audio codec payload, allowing proper extraction and processing of the DTMF event. Additionally, or alternatively, the UE 900 may be configured to support any one or combination of the presence bit being included in a codec payload header of the audio codec payload. This aspect provides a standardized location for the presence indicator, enabling efficient detection of DTMF events at the receiver. Additionally, or alternatively, the UE 900 may be configured to support any one or combination of an end of the DTMF event being indicated by an end bit. This aspect enables the receiver to determine when a DTMF event has concluded, supporting proper event duration tracking and reliability mechanisms.

Additionally, or alternatively, the UE 900 may be configured to support any one or combination of the end bit being included in a codec payload header of the audio codec payload. This aspect provides a standardized location for the end indicator, enabling efficient detection of DTMF event conclusion at the receiver. Additionally, or alternatively, the UE 900 may be configured to support any one or combination of the binary representation of the DTMF event being prefixed to the audio codec payload to form a header extension within a codec payload header of the audio codec payload. This aspect provides an alternative embedding mechanism that preserves the audio coded data in full, avoiding the need for error concealment at the decoder. Additionally, or alternatively, the UE 900 may be configured to support any one or combination of the audio codec payload including the binary representation of the DTMF event as a DTMF-only payload excluding audio coded data. This aspect enables DTMF event transport during silence periods when DTX is enabled and no audio coded data is available.

Additionally, or alternatively, the UE 900 may be configured to support any one or combination of the binary representation of the DTMF event encoding at least a DTMF event identifier. The binary representation of the DTMF event may additionally encode at least an end marker indicating the end of the DTMF event. This aspect reduces the DTMF representation from a conventional 4-byte payload to a compact binary representation, providing significant bandwidth savings in ultra-low bit rate scenarios. Additionally, or alternatively, the UE 900 may be configured to support any one or combination of the lower layer including at least one of an RTP layer, where the audio codec payload is transmitted via RTP over UDP and IP, or a non-IP protocol layer, where the audio codec payload is transmitted over a radio layer-2 protocol. This aspect enables the DTMF embedding techniques herein to be applied to both IP-based transport and non-IP transport mechanisms. Additionally, or alternatively, the UE 900 may be configured to support any one or combination of negotiating, via an SDP offer-answer procedure, at least one of a capability to substitute the binary representation of the DTMF event into the audio codec payload, a fixed duration for the DTMF event, or a default playback volume indication for the DTMF event. This aspect enables interoperability with devices that do not support the embedded DTMF approach and provides a mechanism for auto-cancelling DTMF events after a negotiated duration. This aspect further enables out-of-band signaling of a preferred, or alternatively, default volume associated with the DTMF event playback at a receiver.

Additionally, or alternatively, the UE 900 may be configured to support any one or combination of repeating the substitution of the binary representation of the DTMF event into two or more distinct audio codec payloads. The repetitions in two or more audio codec payloads may result in two or more distinct audio coded packets being released for transmission to lower layers. The two or more audio codec packets may improve DTMF event detection reliability at a receiver node.

Additionally, or alternatively, the UE 900 may be configured to or operable to support a means for receiving an audio codec payload, extracting a binary representation of a DTMF event from the audio codec payload, the binary representation substituted into the audio codec payload, and forwarding the audio codec payload to an audio decoder of the UE 900. In this manner, the UE 900 supports extraction and processing of DTMF events that have been embedded into audio codec payloads, enabling interaction with IVR systems and other automated answering applications in bandwidth-constrained communications. The substitution of the binary representation of the DTMF event into the audio codec payload may comprise embedding the binary representation of the DTMF event into the audio codec payload, in place, without performing audio coding of the DTMF event Additionally, or alternatively, the UE 900 may be configured to support any one or combination of extracting the binary representation of the DTMF event includes recovering the binary representation of the DTMF event from bit positions in the audio codec payload according to a puncturing mask. This aspect enables the receiver to locate and extract the DTMF event identifier from the punctured bit positions in the audio coded data.

Additionally, or alternatively, the UE 900 may be configured to support any one or combination of performing error concealment on the audio codec payload based on the puncturing mask. This aspect mitigates any distortion introduced by the substituted DTMF bits at the punctured positions, improving decoded audio quality. Additionally, or alternatively, the UE 900 may be configured to support any one or combination of extracting the binary representation of the DTMF event includes reading the binary representation of the DTMF event from a header extension of a codec payload header of the audio codec payload. This aspect enables extraction of DTMF events that have been embedded as a header extension rather than punctured into the audio coded data.

Additionally, or alternatively, the UE 900 may be configured to support any one or combination of presence of the binary representation of the DTMF event in the audio codec payload being indicated by a presence bit. This aspect enables the receiver to determine whether DTMF event information is present in the received audio codec payload. Additionally, or alternatively, the UE 900 may be configured to support any one or combination of the presence bit being included in a codec payload header of the audio codec payload. This aspect provides a standardized location for checking the presence indicator at the receiver.

Additionally, or alternatively, the UE 900 may be configured to support any one or combination of an end of the DTMF event being indicated by an end bit. This aspect enables the receiver to determine when a DTMF event has concluded for proper event processing. Additionally, or alternatively, the UE 900 may be configured to support any one or combination of the end bit being included in a codec payload header of the audio codec payload. This aspect provides a standardized location for checking the end indicator at the receiver. Additionally, or alternatively, the UE 900 may be configured to support any one or combination of the audio codec payload including the binary representation of the DTMF event as a DTMF-only payload excluding audio coded data. This aspect enables the receiver to extract DTMF events from payloads transmitted during silence periods when no audio coded data is present.

Additionally, or alternatively, the UE 900 may be configured to support any one or combination of the audio codec payload being received from at least one of an RTP layer, where the audio codec payload is received via RTP over UDP and IP, or a non-IP protocol layer, where the audio codec payload is received over a radio layer-2 protocol. This aspect enables the DTMF extraction techniques to be applied to audio codec payloads received via both IP-based transport and non-IP transport mechanisms. Additionally, or alternatively, the UE 900 may be configured to support any one or combination of the binary representation of the DTMF event encoding at least a DTMF event identifier. The binary representation of the DTMF event may additionally encode at least an end marker indicating the end of the DTMF event. This aspect enables the receiver to identify the specific DTMF digit or character that was pressed by the user. Additionally, or alternatively, the UE 900 may be configured to support any one or combination of negotiating, via an SDP offer-answer procedure, at least one of a capability to extract the binary representation of the DTMF event from the audio codec payload, a fixed duration for the DTMF event, or a default playback volume indication for the DTMF event. This aspect enables the receiver to negotiate support for the embedded DTMF approach and to apply auto-cancellation of DTMF events after a negotiated duration. This aspect further enables out-of-band signaling of a preferred, or alternatively, default volume associated with the DTMF event playback at a receiver.

Additionally, or alternatively, the UE 900 may support at least one memory (e.g., the memory 904) and at least one processor (e.g., the processor 902) coupled with the at least one memory and configured to cause the UE 900 to detect a DTMF event, substitute a binary representation of the DTMF event into an audio codec payload, and release the audio codec payload to a lower layer for transmission. In this manner, the UE 900 supports efficient DTMF transport by embedding DTMF event information directly into the audio codec payload rather than transmitting separate DTMF packets, reducing overhead and conserving bandwidth in bandwidth-constrained communications such as IMS Voice over GEO satellite. Substituting the binary representation of the DTMF event into the audio codec payload may comprise embedding the binary representation of the DTMF event into the audio codec payload, in place, without performing audio coding of the DTMF event.

Additionally, or alternatively, the UE 900 may be configured to support any one or combination of performing distributed bit puncturing on audio coded data in the audio codec payload to provide bit positions for the binary representation of the DTMF event. This aspect enables the DTMF event to be carried without adding additional overhead to the audio codec payload. Additionally, or alternatively, the UE 900 may be configured to support any one or combination of determining a puncturing mask indicating the bit positions, where determining the puncturing mask includes selecting a group of coded audio features based on a reliability pattern of the audio coded data, and selecting, based on the reliability pattern, a set of quantized bits of one or more of the coded audio features. This aspect minimizes perceptual impact on decoded audio quality by selecting bit positions that are robust to errors for puncturing. The set of quantized bits may contain one or more bits. The set of quantized bits may comprise a least significant bit or a most significant bit. Alternatively, the set of quantized bits may comprise a bit with high reliability or a bit with low resolution or low impact for audio perceptual quality. The coded audio features may comprise audio latent feature representations, or alternatively audio latent features. The reliability pattern may include audio latent features with increased robustness to errors.

Additionally, or alternatively, the UE 900 may be configured to support any one or combination of selecting an interleaving pattern for the bit positions indicated by the puncturing mask, and applying the interleaving pattern to interleave the bit positions with remaining bits of the audio coded data. This aspect distributes the punctured bits across the audio coded data to reduce localized distortion. Additionally, or alternatively, the UE 900 may be configured to support any one or combination of substituting the binary representation of the DTMF event includes replacing bits at the bit positions indicated by the puncturing mask with the binary representation of the DTMF event. This aspect provides a mechanism for embedding the DTMF event identifier into the audio coded data. Additionally, or alternatively, the UE 900 may be configured to support any one or combination of presence of the binary representation of the DTMF event in the audio codec payload being indicated by a presence bit. This aspect enables a receiving node to determine whether DTMF event information is present in the audio codec payload.

Additionally, or alternatively, the UE 900 may be configured to support any one or combination of the presence bit being included in a codec payload header of the audio codec payload. This aspect provides a standardized location for the presence indicator. Additionally, or alternatively, the UE 900 may be configured to support any one or combination of an end of the DTMF event is indicated by an end bit. This aspect enables the receiver to determine when a DTMF event has concluded. Additionally, or alternatively, the UE 900 may be configured to support any one or combination of the end bit being included in a codec payload header of the audio codec payload. This aspect provides a standardized location for the end indicator.

Additionally, or alternatively, the UE 900 may be configured to support any one or combination of the binary representation of the DTMF event being prefixed to the audio codec payload to form a header extension included within a codec payload header of the audio codec payload. This aspect provides an alternative embedding mechanism that preserves the audio coded data in full. Additionally, or alternatively, the UE 900 may be configured to support any one or combination of the audio codec payload including the binary representation of the DTMF event as a DTMF-only payload excluding audio coded data. This aspect enables DTMF event transport during silence periods. Additionally, or alternatively, the UE 900 may be configured to support any one or combination of the binary representation of the DTMF event encoding at least a DTMF event identifier. This aspect reduces the DTMF representation to a compact binary representation. The binary representation of the DTMF event may additionally encode at least an end marker indicating the end of the DTMF event.

Additionally, or alternatively, the UE 900 may be configured to support any one or combination of the lower layer including at least one of an RTP layer, where the audio codec payload is transmitted via RTP over UDP and IP, or a non-IP protocol layer, where the audio codec payload is transmitted over a radio layer-2 protocol. This aspect enables the DTMF embedding techniques to be applied to both IP-based transport and non-IP transport mechanisms. Additionally, or alternatively, the UE 900 may be configured to support any one or combination of negotiating, via an SDP offer-answer procedure, at least one of a capability to substitute the binary representation of the DTMF event into the audio codec payload, a fixed duration for the DTMF event, or a default playback volume indication for the DTMF event. This aspect enables interoperability and provides a mechanism for auto-cancelling DTMF events. This aspect further enables out-of-band signaling of a preferred, or alternatively, default volume associated with the DTMF event playback at a receiver.

Additionally, or alternatively, the UE 900 may support at least one memory (e.g., the memory 904) and at least one processor (e.g., the processor 902) coupled with the at least one memory and configured to cause the UE 900 to receive an audio codec payload, extract a binary representation of a DTMF event from the audio codec payload, the binary representation substituted into the audio codec payload, and forward the audio codec payload to an audio decoder of the UE 900. In this manner, the UE 900 supports extraction and processing of DTMF events that have been embedded into audio codec payloads, enabling interaction with IVR systems and other automated answering applications in bandwidth-constrained communications. The substitution of the binary representation of the DTMF event into the audio codec payload may comprise embedding the binary representation of the DTMF event into the audio codec payload, in place, without performing audio coding of the DTMF event

Additionally, or alternatively, the UE 900 may be configured to support any one or combination of extracting the binary representation of the DTMF event includes recovering the binary representation of the DTMF event from bit positions in the audio codec payload according to a puncturing mask. This aspect enables the receiver to locate and extract the DTMF event identifier from the punctured bit positions. Additionally, or alternatively, the UE 900 may be configured to support any one or combination of performing error concealment on the audio codec payload based on the puncturing mask. This aspect mitigates any distortion introduced by the substituted DTMF bits.

Additionally, or alternatively, the UE 900 may be configured to support any one or combination of extracting the binary representation of the DTMF event includes reading the binary representation of the DTMF event from a header extension of a codec payload header of the audio codec payload. This aspect enables extraction of DTMF events embedded as a header extension. Additionally, or alternatively, the UE 900 may be configured to support any one or combination of presence of the binary representation of the DTMF event in the audio codec payload being indicated by a presence bit. This aspect enables the receiver to determine whether DTMF event information is present. Additionally, or alternatively, the UE 900 may be configured to support any one or combination of the presence bit being included in a codec payload header of the audio codec payload. This aspect provides a standardized location for checking the presence indicator.

Additionally, or alternatively, the UE 900 may be configured to support any one or combination of an end of the DTMF event being indicated by an end bit. This aspect enables the receiver to determine when a DTMF event has concluded. Additionally, or alternatively, the UE 900 may be configured to support any one or combination of the end bit being included in a codec payload header of the audio codec payload. This aspect provides a standardized location for checking the end indicator. Additionally, or alternatively, the UE 900 may be configured to support any one or combination of the audio codec payload including the binary representation of the DTMF event as a DTMF-only payload excluding audio coded data. This aspect enables the receiver to extract DTMF events from payloads transmitted during silence periods.

Additionally, or alternatively, the UE 900 may be configured to support any one or combination of the binary representation of the DTMF event encoding at least a DTMF event identifier. This aspect enables the receiver to identify the specific DTMF digit or character. The binary representation of the DTMF event may additionally encode at least an end marker indicating the end of the DTMF event. Additionally, or alternatively, the UE 900 may be configured to support any one or combination of the audio codec payload being received from at least one of an RTP layer, where the audio codec payload is received via RTP over UDP and IP, or a non-IP protocol layer, where the audio codec payload is received over a radio layer-2 protocol. This aspect enables the DTMF extraction techniques to be applied to audio codec payloads received via both transport mechanisms. Additionally, or alternatively, the UE 900 may be configured to support any one or combination of negotiating, via an SDP offer-answer procedure, at least one of a capability to extract the binary representation of the DTMF event from the audio codec payload, a fixed duration for the DTMF event, or a default playback volume indication for the DTMF event. This aspect enables the receiver to negotiate support for the embedded DTMF approach and to apply auto-cancellation of DTMF events. This aspect further enables out-of-band signaling of a preferred, or alternatively, default volume associated with the DTMF event playback at a receiver.

The controller 906 may manage input and output signals for the UE 900. The controller 906 may also manage peripherals not integrated into the UE 900. In some implementations, the controller 906 may utilize an operating system such as iOS®, ANDROID®, WINDOWS®, or other operating systems. In some implementations, the controller 906 may be implemented as part of the processor 902.

In some implementations, the UE 900 may include at least one transceiver 908. In some other implementations, the UE 900 may have more than one transceiver 908. The transceiver 908 may represent a wireless transceiver. The transceiver 908 may include one or more receiver chains 910, one or more transmitter chains 912, or a combination thereof.

A receiver chain 910 may be configured to receive signals (e.g., control information, data, packets) over a wireless medium. For example, the receiver chain 910 may include one or more antennas to receive a signal over the air or wireless medium. The receiver chain 910 may include at least one amplifier (e.g., a low-noise amplifier (LNA)) configured to amplify the received signal. The receiver chain 910 may include at least one demodulator configured to demodulate the receive signal and obtain the transmitted data by reversing the modulation technique applied during transmission of the signal. The receiver chain 910 may include at least one decoder for decoding the demodulated signal to receive the transmitted data.

A transmitter chain 912 may be configured to generate and transmit signals (e.g., control information, data, packets). The transmitter chain 912 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature AM (QAM). The transmitter chain 912 may also include at least one power amplifier configured to amplify the modulated signal to an appropriate power level suitable for transmission over the wireless medium. The transmitter chain 912 may also include one or more antennas for transmitting the amplified signal into the air or wireless medium.

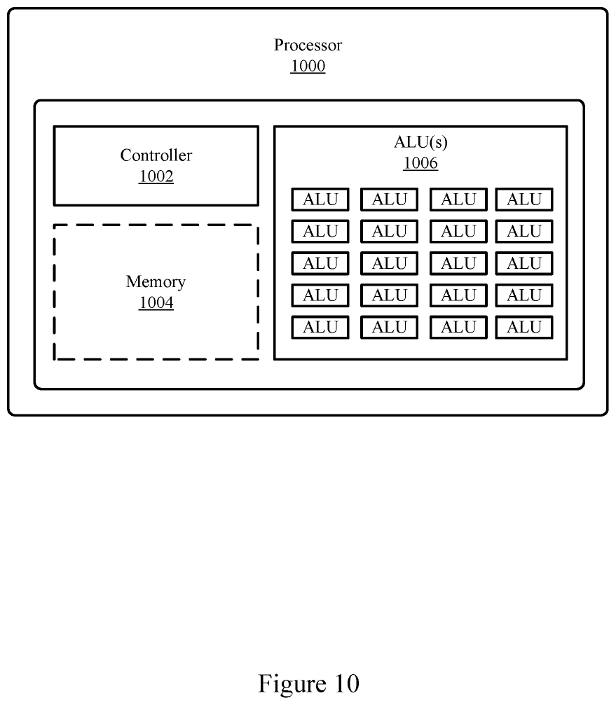

FIG. 10 illustrates an example of a processor 1000 in accordance with aspects of the present disclosure. The processor 1000 may be an example of a processor configured to perform various operations in accordance with examples as described herein. The processor 1000 may include a controller 1002 configured to perform various operations in accordance with examples as described herein. The processor 1000 may optionally include at least one memory 1004, which may be, for example, an L1/L2/L3 cache. Additionally, or alternatively, the processor 1000 may optionally include one or more arithmetic-logic units (ALUs) 1006. One or more of these components may be in electronic communication or otherwise coupled (e.g., operatively, communicatively, functionally, electronically, electrically) via one or more interfaces (e.g., buses).

The processor 1000 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1000) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1002 may be configured to manage and coordinate various operations (e.g., signaling, receiving, obtaining, retrieving, transmitting, outputting, forwarding, storing, determining, identifying, accessing, writing, reading) of the processor 1000 to cause the processor 1000 to support various operations in accordance with examples as described herein. For example, the controller 1002 may operate as a control unit of the processor 1000, generating control signals that manage the operation of various components of the processor 1000. These control signals include enabling or disabling functional units, selecting data paths, initiating memory access, and coordinating timing of operations.

The controller 1002 may be configured to fetch (e.g., obtain, retrieve, receive) instructions from the memory 1004 and determine subsequent instruction(s) to be executed to cause the processor 1000 to support various operations in accordance with examples as described herein. The controller 1002 may be configured to track memory addresses of instructions associated with the memory 1004. The controller 1002 may be configured to decode instructions to determine the operation to be performed and the operands involved. For example, the controller 1002 may be configured to interpret the instruction and determine control signals to be output to other components of the processor 1000 to cause the processor 1000 to support various operations in accordance with examples as described herein. Additionally, or alternatively, the controller 1002 may be configured to manage flow of data within the processor 1000. The controller 1002 may be configured to control transfer of data between registers, ALUs 1006, and other functional units of the processor 1000.

The memory 1004 may include one or more caches (e.g., memory local to or included in the processor 1000 or other memory, such as RAM, ROM, DRAM, SDRAM, SRAM, MRAM, flash memory, etc. In some implementations, the memory 1004 may reside within or on a processor chipset (e.g., local to the processor 1000). In some other implementations, the memory 1004 may reside external to the processor chipset (e.g., remote to the processor 1000).

The memory 1004 may store computer-readable, computer-executable code including instructions that, when executed by the processor 1000, cause the processor 1000 to perform various functions described herein. The code may be stored in a non-transitory computer-readable medium such as system memory or another type of memory. The controller 1002 and/or the processor 1000 may be configured to execute computer-readable instructions stored in the memory 1004 to cause the processor 1000 to perform various functions. For example, the processor 1000 and/or the controller 1002 may be coupled with or to the memory 1004, the processor 1000, and the controller 1002, and may be configured to perform various functions described herein. In some examples, the processor 1000 may include multiple processors and the memory 1004 may include multiple memories. One or more of the multiple processors may be coupled with one or more of the multiple memories, which may, individually or collectively, be configured to perform various functions herein.

The one or more ALUs 1006 may be configured to support various operations in accordance with examples as described herein. In some implementations, the one or more ALUs 1006 may reside within or on a processor chipset (e.g., the processor 1000). In some other implementations, the one or more ALUs 1006 may reside external to the processor chipset (e.g., the processor 1000). One or more ALUs 1006 may perform one or more computations such as addition, subtraction, multiplication, and division on data. For example, one or more ALUs 1006 may receive input operands and an operation code, which determines an operation to be executed. One or more ALUs 1006 may be configured with a variety of logical and arithmetic circuits, including adders, subtractors, shifters, and logic gates, to process and manipulate the data according to the operation. Additionally, or alternatively, the one or more ALUs 1006 may support logical operations such as AND, OR, exclusive-OR (XOR), not-OR (NOR), and not-AND (NAND), enabling the one or more ALUs 1006 to handle conditional operations, comparisons, and bitwise operations.

The processor 1000 may support wireless communication in accordance with examples as disclosed herein. The processor 1000 may be configured to or operable to support at least one controller (e.g., the controller 1002) coupled with at least one memory (e.g., the memory 1004) and configured to cause the processor to detect a DTMF event, substitute a binary representation of the DTMF event into an audio codec payload, and release the audio codec payload to a lower layer for transmission. In this manner, the processor 1000 supports efficient DTMF transport by embedding DTMF event information directly into the audio codec payload rather than transmitting separate DTMF packets, reducing overhead and conserving bandwidth in bandwidth-constrained communications such as IMS Voice over GEO satellite.

Additionally, or alternatively, the processor 1000 may be configured to or operable to support any one or combination of performing distributed bit puncturing on audio coded data in the audio codec payload to provide bit positions for the binary representation of the DTMF event. This aspect enables the DTMF event to be carried without adding additional overhead to the audio codec payload, as the DTMF bits replace existing audio coded data bits at punctured positions. Additionally, or alternatively, the processor 1000 may be configured to or operable to support any one or combination of determining a puncturing mask indicating the bit positions, and to determine the puncturing mask, the processor is configured to select a group of coded audio features based on a reliability pattern of the audio coded data, and select, based on the reliability pattern, a set of quantized bits of one or more of the coded audio features. This aspect minimizes perceptual impact on decoded audio quality by selecting bit positions that are robust to errors for puncturing. The set of quantized bits may contain one or more bits. The set of quantized bits may comprise a least significant bit or a most significant bit. Alternatively, the set of quantized bits may comprise a bit with high reliability or a bit with low resolution or low impact for audio perceptual quality. The coded audio features may comprise audio latent feature representations, or alternatively audio latent features. The reliability pattern may include audio latent features with increased robustness to errors.

Additionally, or alternatively, the processor 1000 may be configured to or operable to support any one or combination of selecting an interleaving pattern for the bit positions indicated by the puncturing mask, and applying the interleaving pattern to interleave the bit positions with remaining bits of the audio coded data. This aspect distributes the punctured bits across the audio coded data to reduce localized distortion and improve error resilience. Additionally, or alternatively, the processor 1000 may be configured to or operable to support any one or combination of substituting the binary representation of the DTMF event includes replacing bits at the bit positions indicated by the puncturing mask with the binary representation of the DTMF event. This aspect provides a mechanism for embedding the DTMF event identifier into the audio coded data without requiring additional header overhead.

Additionally, or alternatively, the processor 1000 may be configured to or operable to support any one or combination of presence of the binary representation of the DTMF event in the audio codec payload being indicated by a presence bit. This aspect enables a receiving node to determine whether DTMF event information is present in the audio codec payload, allowing proper extraction and processing of the DTMF event. Additionally, or alternatively, the processor 1000 may be configured to or operable to support any one or combination of the presence bit being included in a codec payload header of the audio codec payload. This aspect provides a standardized location for the presence indicator, enabling efficient detection of DTMF events at the receiver.

Additionally, or alternatively, the processor 1000 may be configured to or operable to support any one or combination of an end of the DTMF event being indicated by an end bit. This aspect enables the receiver to determine when a DTMF event has concluded, supporting proper event duration tracking and reliability mechanisms. Additionally, or alternatively, the processor 1000 may be configured to or operable to support any one or combination of the end bit being included in a codec payload header of the audio codec payload. This aspect provides a standardized location for the end indicator, enabling efficient detection of DTMF event conclusion at the receiver. Additionally, or alternatively, the processor 1000 may be configured to or operable to support any one or combination of the binary representation of the DTMF event being prefixed to the audio codec payload to form a header extension included within a codec payload header of the audio codec payload. This aspect provides an alternative embedding mechanism that preserves the audio coded data in full, avoiding the need for error concealment at the decoder.

Additionally, or alternatively, the processor 1000 may be configured to or operable to support any one or combination of the audio codec payload including the binary representation of the DTMF event as a DTMF-only payload excluding audio coded data. This aspect enables DTMF event transport during silence periods when DTX is enabled and no audio coded data is available. Additionally, or alternatively, the processor 1000 may be configured to or operable to support any one or combination of the binary representation of the DTMF event encoding at least a DTMF event identifier. The binary representation of the DTMF event may additionally encode at least an end marker indicating the end of the DTMF event. This aspect reduces the DTMF representation from a conventional 4-byte payload to a compact binary representation, providing significant bandwidth savings in ultra-low bit rate scenarios. Additionally, or alternatively, the processor 1000 may be configured to or operable to support any one or combination of the lower layer including at least one of an RTP layer, where the audio codec payload is transmitted via RTP over UDP and IP, or a non-IP protocol layer, where the audio codec payload is transmitted over a radio layer-2 protocol. This aspect enables the DTMF embedding techniques to be applied to both IP-based transport and non-IP transport mechanisms.

Additionally, or alternatively, the processor 1000 may be configured to or operable to support any one or combination of negotiating, via an SDP offer-answer procedure, at least one of a capability to substitute the binary representation of the DTMF event into the audio codec payload, a fixed duration for the DTMF event, or a default playback volume indication for the DTMF event. This aspect enables interoperability with devices that do not support the embedded DTMF approach and provides a mechanism for auto-cancelling DTMF events after a negotiated duration. This aspect further enables out-of-band signaling of a preferred, or alternatively, default volume associated with the DTMF event playback at a receiver.

Additionally, or alternatively, the processor 1000 may be configured to or operable to support any one or combination of repeating the substitution of the binary representation of the DTMF event into two or more distinct audio codec payloads. The repetitions in two or more audio codec payloads may result in two or more distinct audio coded packets being released for transmission to lower layers. The two or more audio codec packets may improve DTMF event detection reliability at a receiver node.

Additionally, or alternatively, the processor 1000 may be configured to or operable to support at least one controller (e.g., the controller 1002) coupled with at least one memory (e.g., the memory 1004) and configured to cause the processor to receive an audio codec payload, extract a binary representation of a DTMF event from the audio codec payload, the binary representation substituted into the audio codec payload, and forward the audio codec payload to an audio decoder. In this manner, the processor 1000 supports extraction and processing of DTMF events that have been embedded into audio codec payloads, enabling interaction with IVR systems and other automated answering applications in bandwidth-constrained communications.

Additionally, or alternatively, the processor 1000 may be configured to or operable to support any one or combination of extracting the binary representation of the DTMF event includes recovering the binary representation of the DTMF event from bit positions in the audio codec payload according to a puncturing mask. This aspect enables the receiver to locate and extract the DTMF event identifier from the punctured bit positions in the audio coded data. Additionally, or alternatively, the processor 1000 may be configured to or operable to support any one or combination of performing error concealment on the audio codec payload based on the puncturing mask. This aspect mitigates any distortion introduced by the substituted DTMF bits at the punctured positions, improving decoded audio quality. Additionally, or alternatively, the processor 1000 may be configured to or operable to support any one or combination of extracting the binary representation of the DTMF event includes reading the binary representation of the DTMF event from a header extension of a codec payload header of the audio codec payload. This aspect enables extraction of DTMF events that have been embedded as a header extension rather than punctured into the audio coded data.

Additionally, or alternatively, the processor 1000 may be configured to or operable to support any one or combination of presence of the binary representation of the DTMF event in the audio codec payload being indicated by a presence bit. This aspect enables the receiver to determine whether DTMF event information is present in the received audio codec payload. Additionally, or alternatively, the processor 1000 may be configured to or operable to support any one or combination of the presence bit being included in a codec payload header of the audio codec payload. This aspect provides a standardized location for checking the presence indicator at the receiver. Additionally, or alternatively, the processor 1000 may be configured to or operable to support any one or combination of an end of the DTMF event being indicated by an end bit. This aspect enables the receiver to determine when a DTMF event has concluded for proper event processing.

Additionally, or alternatively, the processor 1000 may be configured to or operable to support any one or combination of the end bit being included in a codec payload header of the audio codec payload. This aspect provides a standardized location for checking the end indicator at the receiver. Additionally, or alternatively, the processor 1000 may be configured to or operable to support any one or combination of the audio codec payload including the binary representation of the DTMF event as a DTMF-only payload excluding audio coded data. This aspect enables the receiver to extract DTMF events from payloads transmitted during silence periods when no audio coded data is present. Additionally, or alternatively, the processor 1000 may be configured to or operable to support any one or combination of the audio codec payload being received from at least one of an RTP layer, where the audio codec payload is received via RTP over UDP and IP, or a non-IP protocol layer, where the audio codec payload is received over a radio layer-2 protocol. This aspect enables the DTMF extraction techniques to be applied to audio codec payloads received via both IP-based transport and non-IP transport mechanisms.

Additionally, or alternatively, the processor 1000 may be configured to or operable to support any one or combination of the binary representation of the DTMF event encodes at least a DTMF event identifier. The binary representation of the DTMF event may additionally encode at least an end marker indicating the end of the DTMF event. This aspect enables the receiver to identify the specific DTMF digit or character that was pressed by the user. Additionally, or alternatively, the processor 1000 may be configured to or operable to support any one or combination of negotiating, via an SDP offer-answer procedure, at least one of a capability to extract the binary representation of the DTMF event from the audio codec payload, a fixed duration for the DTMF event, or a default playback volume indication for the DTMF event. This aspect enables the receiver to negotiate support for the embedded DTMF approach and to apply auto-cancellation of DTMF events after a negotiated duration. This aspect further enables out-of-band signaling of a preferred, or alternatively, default volume associated with the DTMF event playback at a receiver.

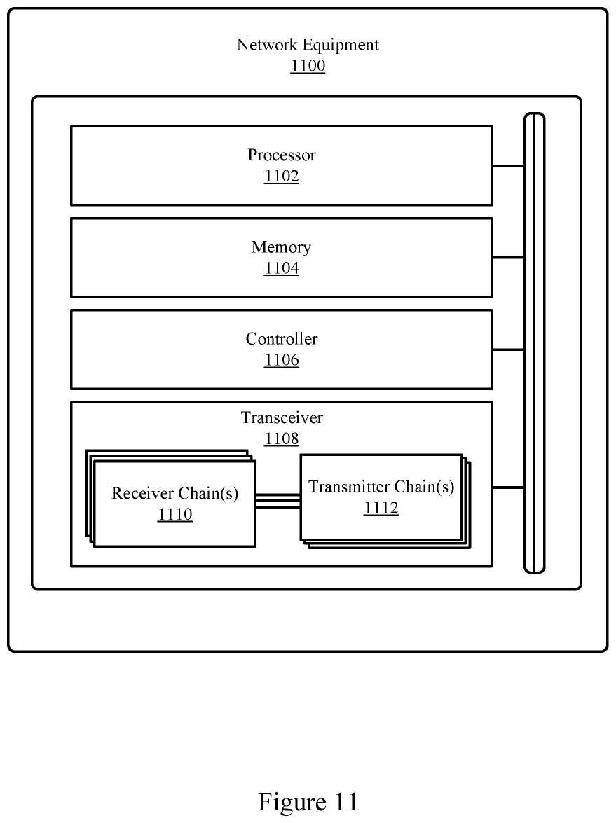

FIG. 11 illustrates an example of an NE 1100 in accordance with aspects of the present disclosure. The NE 1100 may include a processor 1102, a memory 1104, a controller 1106, and a transceiver 1108. The processor 1102, the memory 1104, the controller 1106, or the transceiver 1108, or various combinations thereof or various components thereof may be examples of means for performing various aspects of the present disclosure as described herein. These components may be coupled (e.g., operatively, communicatively, functionally, electronically, electrically) via one or more interfaces.

The processor 1102, the memory 1104, the controller 1106, or the transceiver 1108, or various combinations or components thereof may be implemented in hardware (e.g., circuitry). The hardware may include a processor, a DSP, an ASIC, or other programmable logic device, or any combination thereof configured as or otherwise supporting a means for performing the functions described in the present disclosure.

The processor 1102 may include an intelligent hardware device (e.g., a general-purpose processor, a DSP, a CPU, an ASIC, an FPGA, or any combination thereof). In some implementations, the processor 1102 may be configured to operate the memory 1104. In some other implementations, the memory 1104 may be integrated into the processor 1102. The processor 1102 may be configured to execute computer-readable instructions stored in the memory 1104 to cause the NE 1100 to perform various functions of the present disclosure.

The memory 1104 may include volatile or non-volatile memory. The memory 1104 may store computer-readable, computer-executable code including instructions when executed by the processor 1102 cause the NE 1100 to perform various functions described herein. The code may be stored in a non-transitory computer-readable medium such as the memory 1104 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1102 and the memory 1104 coupled with the processor 1102 may be configured to cause the NE 1100 to perform one or more of the functions described herein (e.g., executing, by the processor 1102, instructions stored in the memory 1104). For example, the processor 1102 may support wireless communication at the NE 1100 in accordance with examples as disclosed herein. The NE 1100 may be configured to or operable to support a means for detecting a DTMF event, substituting a binary representation of the DTMF event into an audio codec payload, and releasing the audio codec payload to a lower layer for transmission. In this manner, the NE 1100 supports efficient DTMF transport by embedding DTMF event information directly into the audio codec payload rather than transmitting separate DTMF packets, reducing overhead and conserving bandwidth in bandwidth-constrained communications such as IMS Voice over GEO satellite.

Additionally, or alternatively, the NE 1100 may be configured to support any one or combination of performing distributed bit puncturing on audio coded data in the audio codec payload to provide bit positions for the binary representation of the DTMF event. This aspect enables the DTMF event to be carried without adding additional overhead to the audio codec payload, as the DTMF bits replace existing audio coded data bits at punctured positions. Additionally, or alternatively, the NE 1100 may be configured to support any one or combination of determining a puncturing mask indicating the bit positions, where determining the puncturing mask includes selecting a group of coded audio features based on a reliability pattern of the audio coded data, and selecting, based on the reliability pattern, a set of quantized bits of one or more of the coded audio features. This aspect minimizes perceptual impact on decoded audio quality by selecting bit positions that are robust to errors for puncturing. The set of quantized bits may contain one or more bits. The set of quantized bits may comprise a least significant bit or a most significant bit. Alternatively, the set of quantized bits may comprise a bit with high reliability or a bit with low resolution or low impact for audio perceptual quality. The coded audio features may comprise audio latent feature representations, or alternatively audio latent features. The reliability pattern may include audio latent features with increased robustness to errors.

Additionally, or alternatively, the NE 1100 may be configured to support any one or combination of selecting an interleaving pattern for the bit positions indicated by the puncturing mask, and applying the interleaving pattern to interleave the bit positions with remaining bits of the audio coded data. This aspect distributes the punctured bits across the audio coded data to reduce localized distortion and improve error resilience. Additionally, or alternatively, the NE 1100 may be configured to support any one or combination of substituting the binary representation of the DTMF event includes replacing bits at the bit positions indicated by the puncturing mask with the binary representation of the DTMF event. This aspect provides a mechanism for embedding the DTMF event identifier into the audio coded data without requiring additional header overhead.

Additionally, or alternatively, the NE 1100 may be configured to support any one or combination of presence of the binary representation of the DTMF event in the audio codec payload being indicated by a presence bit. This aspect enables a receiving node to determine whether DTMF event information is present in the audio codec payload, allowing proper extraction and processing of the DTMF event. Additionally, or alternatively, the NE 1100 may be configured to support any one or combination of the presence bit being included in a codec payload header of the audio codec payload. This aspect provides a standardized location for the presence indicator, enabling efficient detection of DTMF events at the receiver.

Additionally, or alternatively, the NE 1100 may be configured to support any one or combination of an end of the DTMF event being indicated by an end bit. This aspect enables the receiver to determine when a DTMF event has concluded, supporting proper event duration tracking and reliability mechanisms. Additionally, or alternatively, the NE 1100 may be configured to support any one or combination of the end bit being included in a codec payload header of the audio codec payload. This aspect provides a standardized location for the end indicator, enabling efficient detection of DTMF event conclusion at the receiver. Additionally, or alternatively, the NE 1100 may be configured to support any one or combination of the binary representation of the DTMF event being prefixed to the audio codec payload to form a header extension included within a codec payload header of the audio codec payload. This aspect provides an alternative embedding mechanism that preserves the audio coded data in full, avoiding the need for error concealment at the decoder.

Additionally, or alternatively, the NE 1100 may be configured to support any one or combination of the audio codec payload including the binary representation of the DTMF event as a DTMF-only payload excluding audio coded data. This aspect enables DTMF event transport during silence periods when DTX is enabled and no audio coded data is available. Additionally, or alternatively, the NE 1100 may be configured to support any one or combination of encoding at least a DTMF event identifier. The binary representation of the DTMF event may additionally encode at least an end marker indicating the end of the DTMF event. This aspect reduces the DTMF representation from a conventional 4-byte payload to a compact binary representation, providing significant bandwidth savings in ultra-low bit rate scenarios. Additionally, or alternatively, the NE 1100 may be configured to support any one or combination of the lower layer including at least one of an RTP layer, where the audio codec payload is transmitted via RTP over UDP and IP, or a non-IP protocol layer, where the audio codec payload is transmitted over a radio layer-2 protocol. This aspect enables the DTMF embedding techniques to be applied to both IP-based transport and non-IP transport mechanisms.

Additionally, or alternatively, the NE 1100 may be configured to support any one or combination of negotiating, via an SDP offer-answer procedure, at least one of a capability to substitute the binary representation of the DTMF event into the audio codec payload, a fixed duration for the DTMF event, or a default playback volume indication for the DTMF event. This aspect enables interoperability with devices that do not support the embedded DTMF approach and provides a mechanism for auto-cancelling DTMF events after a negotiated duration. This aspect further enables out-of-band signaling of a preferred, or alternatively, default volume associated with the DTMF event playback at a receiver.

Additionally, or alternatively, the NE 1100 may be configured to support any one or combination of repeating the substitution of the binary representation of the DTMF event into two or more distinct audio codec payloads. The repetitions in two or more audio codec payloads may result in two or more distinct audio coded packets being released for transmission to lower layers. The two or more audio codec packets may improve DTMF event detection reliability at a receiver node.

Additionally, or alternatively, the NE 1100 may be configured to or operable to support a means for receiving an audio codec payload, extracting a binary representation of a DTMF event from the audio codec payload, the binary representation substituted into the audio codec payload, and forwarding the audio codec payload to an audio decoder of the NE 1100. In this manner, the NE 1100 supports extraction and processing of DTMF events that have been embedded into audio codec payloads, enabling interaction with IVR systems and other automated answering applications in bandwidth-constrained communications.

Additionally, or alternatively, the NE 1100 may be configured to support any one or combination of extracting the binary representation of the DTMF event includes recovering the binary representation of the DTMF event from bit positions in the audio codec payload according to a puncturing mask. This aspect enables the receiver to locate and extract the DTMF event identifier from the punctured bit positions in the audio coded data. Additionally, or alternatively, the NE 1100 may be configured to support any one or combination of performing error concealment on the audio codec payload based on the puncturing mask. This aspect mitigates any distortion introduced by the substituted DTMF bits at the punctured positions, improving decoded audio quality. Additionally, or alternatively, the NE 1100 may be configured to support any one or combination of extracting the binary representation of the DTMF event includes reading the binary representation of the DTMF event from a header extension of a codec payload header of the audio codec payload. This aspect enables extraction of DTMF events that have been embedded as a header extension rather than punctured into the audio coded data.

Additionally, or alternatively, the NE 1100 may be configured to support any one or combination of presence of the binary representation of the DTMF event in the audio codec payload being indicated by a presence bit. This aspect enables the receiver to determine whether DTMF event information is present in the received audio codec payload. Additionally, or alternatively, the NE 1100 may be configured to support any one or combination of the presence bit being included in a codec payload header of the audio codec payload. This aspect provides a standardized location for checking the presence indicator at the receiver. Additionally, or alternatively, the NE 1100 may be configured to support any one or combination of an end of the DTMF event being indicated by an end bit. This aspect enables the receiver to determine when a DTMF event has concluded for proper event processing.

Additionally, or alternatively, the NE 1100 may be configured to support any one or combination of the end bit being included in a codec payload header of the audio codec payload. This aspect provides a standardized location for checking the end indicator at the receiver. Additionally, or alternatively, the NE 1100 may be configured to support any one or combination of the audio codec payload including the binary representation of the DTMF event as a DTMF-only payload excluding audio coded data. This aspect enables the receiver to extract DTMF events from payloads transmitted during silence periods when no audio coded data is present. Additionally, or alternatively, the NE 1100 may be configured to support any one or combination of the audio codec payload being received from at least one of an RTP layer, where the audio codec payload is received via RTP over UDP and IP, or a non-IP protocol layer, where the audio codec payload is received over a radio layer-2 protocol. This aspect enables the DTMF extraction techniques to be applied to audio codec payloads received via both IP-based transport and non-IP transport mechanisms.

Additionally, or alternatively, the NE 1100 may be configured to support any one or combination of the binary representation of the DTMF event encoding at least a DTMF event identifier. The binary representation of the DTMF event may additionally encode at least an end marker indicating the end of the DTMF event. This aspect enables the receiver to identify the specific DTMF digit or character that was pressed by the user. Additionally, or alternatively, the NE 1100 may be configured to support any one or combination of negotiating, via an SDP offer-answer procedure, at least one of a capability to extract the binary representation of the DTMF event from the audio codec payload, a fixed duration for the DTMF event, or a default playback volume indication for the DTMF event. This aspect enables the receiver to negotiate support for the embedded DTMF approach and to apply auto-cancellation of DTMF events after a negotiated duration. This aspect further enables out-of-band signaling of a preferred, or alternatively, default volume associated with the DTMF event playback at a receiver.

Additionally, or alternatively, the NE 1100 may support at least one memory (e.g., the memory 1104) and at least one processor (e.g., the processor 1102) coupled with the at least one memory and configured to cause the NE 1100 to detect a DTMF event, substitute a binary representation of the DTMF event into an audio codec payload, and release the audio codec payload to a lower layer for transmission. In this manner, the NE 1100 supports efficient DTMF transport by embedding DTMF event information directly into the audio codec payload rather than transmitting separate DTMF packets, reducing overhead and conserving bandwidth in bandwidth-constrained communications such as IMS Voice over GEO satellite.

Additionally, or alternatively, the NE 1100 may be configured to support any one or combination of performing distributed bit puncturing on audio coded data in the audio codec payload to provide bit positions for the binary representation of the DTMF event. This aspect enables the DTMF event to be carried without adding additional overhead to the audio codec payload. Additionally, or alternatively, the NE 1100 may be configured to support any one or combination of determining a puncturing mask indicating the bit positions, where determining the puncturing mask includes selecting a group of coded audio features based on a reliability pattern of the audio coded data, and selecting, based on the reliability pattern, a set of quantized bits of one or more of the coded audio features. This aspect minimizes perceptual impact on decoded audio quality by selecting bit positions that are robust to errors for puncturing. The set of quantized bits may contain one or more bits. The set of quantized bits may comprise a least significant bit or a most significant bit. Alternatively, the set of quantized bits may comprise a bit with high reliability or a bit with low resolution or low impact for audio perceptual quality. The coded audio features may comprise audio latent feature representations, or alternatively audio latent features. The reliability pattern may include audio latent features with increased robustness to errors.

Additionally, or alternatively, the NE 1100 may be configured to support any one or combination of selecting an interleaving pattern for the bit positions indicated by the puncturing mask, and applying the interleaving pattern to interleave the bit positions with remaining bits of the audio coded data. This aspect distributes the punctured bits across the audio coded data to reduce localized distortion. Additionally, or alternatively, the NE 1100 may be configured to support any one or combination of substituting the binary representation of the DTMF event includes replacing bits at the bit positions indicated by the puncturing mask with the binary representation of the DTMF event. This aspect provides a mechanism for embedding the DTMF event identifier into the audio coded data.

Additionally, or alternatively, the NE 1100 may be configured to support any one or combination of presence of the binary representation of the DTMF event in the audio codec payload being indicated by a presence bit. This aspect enables a receiving node to determine whether DTMF event information is present in the audio codec payload. Additionally, or alternatively, the NE 1100 may be configured to support any one or combination of the presence bit being included in a codec payload header of the audio codec payload. This aspect provides a standardized location for the presence indicator. Additionally, or alternatively, the NE 1100 may be configured to support any one or combination of an end of the DTMF event being indicated by an end bit. This aspect enables the receiver to determine when a DTMF event has concluded.

Additionally, or alternatively, the NE 1100 may be configured to support any one or combination of the end bit being included in a codec payload header of the audio codec payload. This aspect provides a standardized location for the end indicator. Additionally, or alternatively, the NE 1100 may be configured to support any one or combination of the binary representation of the DTMF event being prefixed to the audio codec payload to form a header extension included within a codec payload header of the audio codec payload. This aspect provides an alternative embedding mechanism that preserves the audio coded data in full. Additionally, or alternatively, the NE 1100 may be configured to support any one or combination of the audio codec payload including the binary representation of the DTMF event as a DTMF-only payload excluding audio coded data. This aspect enables DTMF event transport during silence periods.

Additionally, or alternatively, the NE 1100 may be configured to support any one or combination of the binary representation of the DTMF event encoding at least a DTMF event identifier. The binary representation of the DTMF event may additionally encode at least an end marker indicating the end of the DTMF event. This aspect reduces the DTMF representation to a compact binary representation. Additionally, or alternatively, the NE 1100 may be configured to support any one or combination of the lower layer including at least one of an RTP layer, where the audio codec payload is transmitted via RTP over UDP and IP, or a non-IP protocol layer, where the audio codec payload is transmitted over a radio layer-2 protocol. This aspect enables the DTMF embedding techniques to be applied to both IP-based transport and non-IP transport mechanisms. Additionally, or alternatively, the NE 1100 may be configured to support any one or combination of negotiating, via an SDP offer-answer procedure, at least one of a capability to substitute the binary representation of the DTMF event into the audio codec payload, a fixed duration for the DTMF event, or a default playback volume indication for the DTMF event. This aspect enables interoperability and provides a mechanism for auto-cancelling DTMF events. This aspect further enables out-of-band signaling of a preferred, or alternatively, default volume associated with the DTMF event playback at a receiver.

Additionally, or alternatively, the NE 1100 may be configured to support any one or combination of repeating the substitution of the binary representation of the DTMF event into two or more distinct audio codec payloads. The repetitions in two or more audio codec payloads may result in two or more distinct audio coded packets being released for transmission to lower layers. The two or more audio codec packets may improve DTMF event detection reliability at a receiver node.

Additionally, or alternatively, the NE 1100 may support at least one memory (e.g., the memory 1104) and at least one processor (e.g., the processor 1102) coupled with the at least one memory and configured to cause the NE 1100 to receive an audio codec payload, extract a binary representation of a DTMF event from the audio codec payload, the binary representation substituted into the audio codec payload, and forward the audio codec payload to an audio decoder of the NE 1100. In this manner, the NE 1100 supports extraction and processing of DTMF events that have been embedded into audio codec payloads, enabling interaction with IVR systems and other automated answering applications in bandwidth-constrained communications.

Additionally, or alternatively, the NE 1100 may be configured to support any one or combination of extracting the binary representation of the DTMF event includes recovering the binary representation of the DTMF event from bit positions in the audio codec payload according to a puncturing mask. This aspect enables the receiver to locate and extract the DTMF event identifier from the punctured bit positions. Additionally, or alternatively, the NE 1100 may be configured to support any one or combination of performing error concealment on the audio codec payload based on the puncturing mask. This aspect mitigates any distortion introduced by the substituted DTMF bits.

Additionally, or alternatively, the NE 1100 may be configured to support any one or combination of extracting the binary representation of the DTMF event includes reading the binary representation of the DTMF event from a header extension of a codec payload header of the audio codec payload. This aspect enables extraction of DTMF events embedded as a header extension. Additionally, or alternatively, the NE 1100 may be configured to support any one or combination of presence of the binary representation of the DTMF event in the audio codec payload being indicated by a presence bit. This aspect enables the receiver to determine whether DTMF event information is present.

Additionally, or alternatively, the NE 1100 may be configured to support any one or combination of the presence bit being included in a codec payload header of the audio codec payload. This aspect provides a standardized location for checking the presence indicator. Additionally, or alternatively, the NE 1100 may be configured to support any one or combination of an end of the DTMF event being indicated by an end bit. This aspect enables the receiver to determine when a DTMF event has concluded. Additionally, or alternatively, the NE 1100 may be configured to support any one or combination of the end bit being included in a codec payload header of the audio codec payload. This aspect provides a standardized location for checking the end indicator.

Additionally, or alternatively, the NE 1100 may be configured to support any one or combination of the audio codec payload including the binary representation of the DTMF event as a DTMF-only payload excluding audio coded data. This aspect enables the receiver to extract DTMF events from payloads transmitted during silence periods. Additionally, or alternatively, the NE 1100 may be configured to support any one or combination of the binary representation of the DTMF event encoding at least a DTMF event identifier. This aspect enables the receiver to identify the specific DTMF digit or character. Additionally, or alternatively, the NE 1100 may be configured to support any one or combination of the audio codec payload being received from at least one of an RTP layer, where the audio codec payload is received via RTP over UDP and IP, or a non-IP protocol layer, where the audio codec payload is received over a radio layer-2 protocol. This aspect enables the DTMF extraction techniques to be applied to audio codec payloads received via both transport mechanisms.

Additionally, or alternatively, the NE 1100 may be configured to support any one or combination of negotiating, via an SDP offer-answer procedure, at least one of a capability to extract the binary representation of the DTMF event from the audio codec payload, a fixed duration for the DTMF event, or a default playback volume indication for the DTMF event. This aspect enables the receiver to negotiate support for the embedded DTMF approach and to apply auto-cancellation of DTMF events. This aspect further enables out-of-band signaling of a preferred, or alternatively, default volume associated with the DTMF event playback at a receiver.

The controller 1106 may manage input and output signals for the NE 1100. The controller 1106 may also manage peripherals not integrated into the NE 1100. In some implementations, the controller 1106 may utilize an operating system such as iOS®, ANDROID®, WINDOWS®, or other operating systems. In some implementations, the controller 1106 may be implemented as part of the processor 1102.

In some implementations, the NE 1100 may include at least one transceiver 1108. In some other implementations, the NE 1100 may have more than one transceiver 1108. The transceiver 1108 may represent a wireless transceiver. The transceiver 1108 may include one or more receiver chains 1110, one or more transmitter chains 1112, or a combination thereof.

A receiver chain 1110 may be configured to receive signals (e.g., control information, data, packets) over a wireless medium. For example, the receiver chain 1110 may include one or more antennas to receive a signal over the air or wireless medium. The receiver chain 1110 may include at least one amplifier (e.g., an LNA) configured to amplify the received signal. The receiver chain 1110 may include at least one demodulator configured to demodulate the receive signal and obtain the transmitted data by reversing the modulation technique applied during transmission of the signal. The receiver chain 1110 may include at least one decoder for decoding the demodulated signal to receive the transmitted data.

A transmitter chain 1112 may be configured to generate and transmit signals (e.g., control information, data, packets). The transmitter chain 1112 may include at least one modulator for modulating data onto a carrier signal, preparing the signal for transmission over a wireless medium. The at least one modulator may be configured to support one or more techniques such as AM, FM, or digital modulation schemes like PSK or QAM. The transmitter chain 1112 may also include at least one power amplifier configured to amplify the modulated signal to an appropriate power level suitable for transmission over the wireless medium. The transmitter chain 1112 may also include one or more antennas for transmitting the amplified signal into the air or wireless medium.

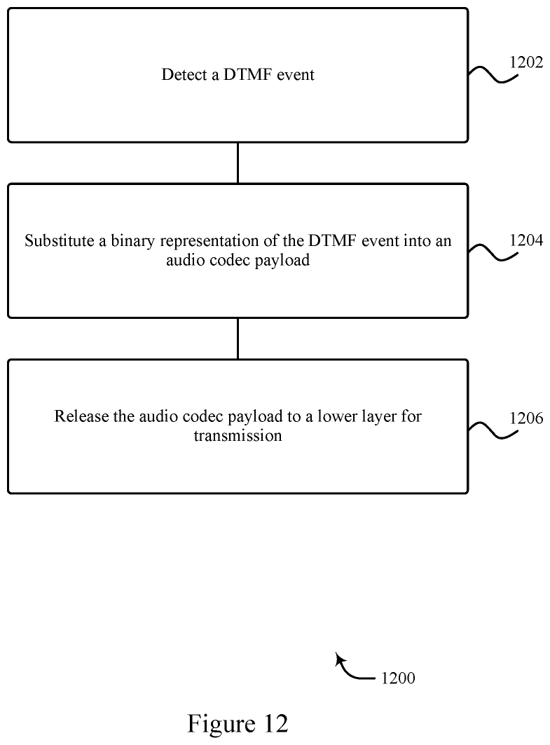

FIG. 12 illustrates a flowchart of a method 1200 in accordance with aspects of the present disclosure. The operations of the method may be implemented by a UE or an NE as described herein. In some implementations, the UE or NE may execute a set of instructions to control the function elements of the UE or NE to perform the described functions. It should be noted that the method described herein describes a possible implementation, and that the operations and the steps may be rearranged or otherwise modified and that other implementations are possible.

At 1202, the method may include detecting a DTMF event. The operations of 1202 may be performed in accordance with examples as described herein. In some implementations, aspects of the operations of 1202 may be performed by a UE as described with reference to FIG. 9 or an NE as described with reference to FIG. 11.

At 1204, the method may include substituting a binary representation of the DTMF event into an audio codec payload. The operations of 1204 may be performed in accordance with examples as described herein. In some implementations, aspects of the operations of 1204 may be performed by a UE as described with reference to FIG. 9 or an NE as described with reference to FIG. 11. Substituting the binary representation of the DTMF event into the audio codec payload may comprise embedding the binary representation of the DTMF event into the audio codec payload, in place, without performing audio coding of the DTMF event.

At 1206, the method may include releasing the audio codec payload to a lower layer for transmission. The operations of 1206 may be performed in accordance with examples as described herein. In some implementations, aspects of the operations of 1206 may be performed by a UE as described with reference to FIG. 9 or an NE as described with reference to FIG. 11.

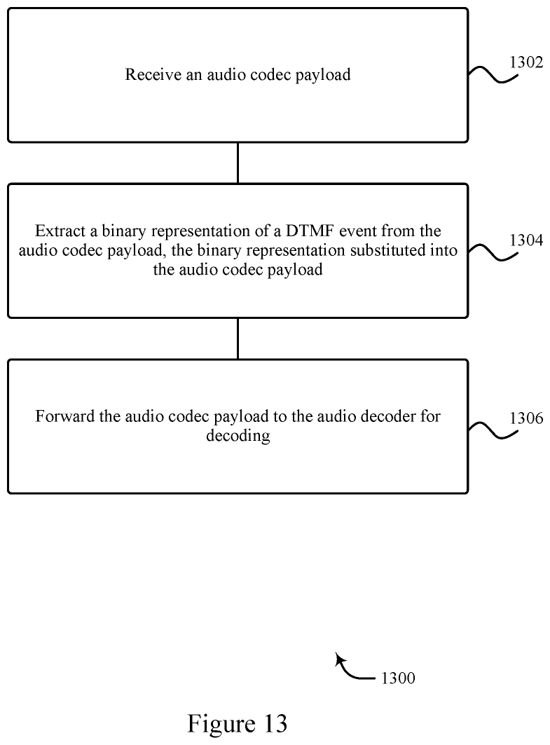

FIG. 13 illustrates a flowchart of a method 1300 in accordance with aspects of the present disclosure. The operations of the method may be implemented by a UE or an NE as described herein. In some implementations, the UE or NE may execute a set of instructions to control the function elements of the UE or NE to perform the described functions. It should be noted that the method described herein describes a possible implementation, and that the operations and the steps may be rearranged or otherwise modified and that other implementations are possible.

At 1302, the method may include receiving an audio codec payload. The operations of 1302 may be performed in accordance with examples as described herein. In some implementations, aspects of the operations of 1302 may be performed by a UE as described with reference to FIG. 9 or an NE as described with reference to FIG. 11.

At 1304, the method may include extracting a binary representation of a DTMF event from the audio codec payload, the binary representation substituted into the audio codec payload. The operations of 1304 may be performed in accordance with examples as described herein. In some implementations, aspects of the operations of 1304 may be performed by a UE as described with reference to FIG. 9 or an NE as described with reference to FIG. 11. The substitution of the binary representation of the DTMF event into the audio codec payload may comprise embedding the binary representation of the DTMF event into the audio codec payload, in place, without performing audio coding of the DTMF event.

At 1306, the method may include forwarding the audio codec payload to an audio decoder for decoding. The operations of 1306 may be performed in accordance with examples as described herein. In some implementations, aspects of the operations of 1306 may be performed by a UE as described with reference to FIG. 9 or an NE as described with reference to FIG. 11.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A node for wireless communication, comprising:
at least one memory; and
at least one processor coupled with the at least one memory and operable to cause the node to:
detect a dual-tone multi-frequency (DTMF) event;
substitute a binary representation of the DTMF event into an audio codec payload; and
release the audio codec payload to a lower layer for transmission.

2. The node of claim 1, wherein the at least one processor is further operable to cause the node to perform distributed bit puncturing on audio coded data in the audio codec payload to provide bit positions for the binary representation of the DTMF event.

3. The node of claim 2, wherein the at least one processor is further operable to cause the node to determine a puncturing mask indicating the bit positions, and to determine the puncturing mask, the at least one processor is operable to cause the node to:
select a group of coded audio features based at least in part on a reliability pattern of the audio coded data; and
select, based at least in part on the reliability pattern, a set of quantized bits of one or more of the coded audio features.

4. The node of claim 3, wherein the at least one processor is further operable to cause the node to:
select an interleaving pattern for the bit positions indicated by the puncturing mask; and
apply the interleaving pattern to interleave the bit positions with remaining bits of the audio coded data.

5. The node of claim 3, wherein, to substitute the binary representation of the DTMF event, the at least one processor is operable to cause the node to replace bits at the bit positions indicated by the puncturing mask with the binary representation of the DTMF event.

6. The node of claim 1, wherein presence of the binary representation of the DTMF event in the audio codec payload is indicated by a presence bit, and wherein the presence bit is included in a codec payload header of the audio codec payload.

7. The node of claim 1, wherein an end of the DTMF event is indicated by an end bit.

8. The node of claim 7, wherein the end bit is included in a codec payload header of the audio codec payload.

9. The node of claim 1, wherein the binary representation of the DTMF event is prefixed to the audio codec payload to form a header extension included within a codec payload header of the audio codec payload.

10. The node of claim 1, wherein the audio codec payload comprises the binary representation of the DTMF event as a DTMF-only payload excluding audio coded data.

11. The node of claim 1, wherein the binary representation of the DTMF event encodes at least a DTMF event identifier.

12. The node of claim 1, wherein the lower layer comprises at least one of:
a real-time transport protocol (RTP) layer, wherein the audio codec payload is transmitted via RTP over user datagram protocol (UDP) and Internet protocol (IP); or
a non-IP protocol layer, wherein the audio codec payload is transmitted over a radio layer-2 protocol.

13. The node of claim 1, wherein the at least one processor is further operable to cause the node to negotiate, via a session description protocol (SDP) offer-answer procedure, at least one of:
a capability to substitute the binary representation of the DTMF event into the audio codec payload;
a fixed duration for the DTMF event; or
a default playback volume indication for the DTMF event.

14. The node of claim 1, wherein the at least one processor is further operable to cause the node to repeat the substitution of the binary representation of the DTMF event into two or more distinct audio codec payloads.

15. A node for wireless communication, comprising:
at least one memory; and
at least one processor coupled with the at least one memory and operable to cause the node to:
receive an audio codec payload;
extract a binary representation of a dual-tone multi-frequency (DTMF) event from the audio codec payload, the binary representation substituted into the audio codec payload; and
forward the audio codec payload to an audio decoder for decoding.

16. The node of claim 15, wherein, to extract the binary representation of the DTMF event, the at least one processor is operable to cause the node to recover the binary representation of the DTMF event from bit positions in the audio codec payload according to a puncturing mask.

17. The node of claim 16, wherein the at least one processor is further operable to cause the node to perform error concealment on the audio codec payload based at least in part on the puncturing mask.

18. The node of claim 15, wherein, to extract the binary representation of the DTMF event, the at least one processor is operable to cause the node to read the binary representation of the DTMF event from a header extension of a codec payload header of the audio codec payload.

19. A method performed by a node, comprising:
detecting a dual-tone multi-frequency (DTMF) event;
substituting a binary representation of the DTMF event into an audio codec payload; and
releasing the audio codec payload to a lower layer for transmission.

20. A method performed by a node, comprising:
receiving an audio codec payload;
extracting a binary representation of a dual-tone multi-frequency (DTMF) event from the audio codec payload, the binary representation substituted into the audio codec payload; and
forwarding the audio codec payload to an audio decoder for decoding.
